(19) United States
(12) Patent Application Publication
(10) Pub. No.: US 2026/0363252 A1
(43) Pub. Date: Nov. 19, 2026

(54) Plant Treatment Compositions Comprising Chitosan-Coated Emulsions

(71) Applicant: UNIVERSITÄT MÜNSTER, Münster (DE)

(72) Inventors: Bruno MOERSCHBACHER, Münster (DE); Carolin RICHTER, Havixbeck (DE); Sruthi SREEKUMAR, Berlin (DE)

(73) Assignee: UNIVERSITÄT MÜNSTER, Münster (DE)

(21) Appl. No.: 19/148,266

(22) PCT Filed: Jan. 19, 2024
(86) PCT No.: PCT/EP2024/051272

§ 371 Date: Jul. 15, 2025

(30) Foreign Application Priority Data
Jan. 20, 2023 (DE) 10 2023 101 458.7

(51) Int. Cl. A01N 65/22; A01N 25/04; A01N 25/10; A01N 25/26; A01N 31/02; A01N 31/08; A01N 65/28; A01P 3/00

(52) U.S. Cl. CPC A01N 65/22; A01N 25/04; A01N 25/10; A01N 25/26; A01N 31/02; A01N 31/08; A01N 65/28; A01P 3/00

(57) ABSTRACT

The present invention is in the field of plant cultivation and treatment and relates to plant treatment compositions that comprise a chitosan-coated emulsion in form of an o/w emulsion, wherein the emulsion comprises a continuous aqueous phase and a dispersed phase in form of droplets dispersed in the continuous phase, wherein each droplet is at least partially coated with at least one chitosan and comprises at least one emulsifier, at least one agricultural active and optionally at least one carrier. The invention further relates to methods of preparation thereof as well as methods of use and uses thereof.

### FILED OF THE INVENTION

The present invention is in the field of plant cultivation and treatment and relates to plant treatment compositions that comprise a chitosan-coated emulsion in form of an o/w emulsion, wherein the emulsion comprises a continuous aqueous phase and a dispersed phase in form of droplets dispersed in the continuous phase, wherein each droplet is at least partially coated with at least one chitosan and comprises at least one emulsifier, at least one agricultural active and optionally at least one carrier. The invention further relates to methods of preparation thereof as well as methods of use and uses thereof.

### BACKGROUND

Plant-derived lipophilic molecules such as essential oils and other plant extracts have desirable plant protection properties, examples of which include antimicrobial and/or insecticidal activity. However, they are often characterized by their low solubility in water, complicating and hampering application and use thereof. In addition, many of these components are sensitive to oxygen, light, moisture, and heat, which represents another major drawback for many applications. Therefore, to harness their full potential, novel techniques are needed that can produce stable formulations using such molecules and mixtures thereof.

In addition to such plant-derived lipophilic molecules, a multitude of other lipophilic molecules that are known for their plant protection and growth stimulating properties are known and widely used in the field of agricultural applications. Successful formulation of such molecules is similarly challenging.

Many of the existing formulation technologies rely on carriers, excipients and auxiliaries that have drawbacks in that they have undesirable environmental effects or are produced from fossil raw material sources. There is thus need in the art for alternative formulations means that allow to effectively formulate a multitude of different agrochemical actives, including plant-derived as well as chemically synthesized molecules.

### SUMMARY OF THE INVENTION

The inventors of the present invention have surprisingly found that chitosans, a type of naturally occurring polymer, can be used to form stable emulsions of lipophilic molecules used in agricultural applications, wherein the individual droplets of the dispersed phase are coated with chitosan polymers and/or oligomers. The inventors have further found that such formulations are particularly useful, as the chitosans do not only have beneficial impact on emulsion formation and stability but additionally provide for additional antimicrobial and/or plant stimulant activity.

The methods, uses and products of the present invention therefore allow for the harnessing of the bioactive potential and properties of both lipophilic agricultural actives and chitosans. Both types of actives can be formulated in combination, resulting in stable o/w (oil-in-water) emulsions allowing for advantageous application of both of said actives, in particular in the agricultural sector.

In a first aspect, the present invention is therefore directed to a plant treatment composition comprising a chitosan-coated emulsion, said chitosan-coated emulsion being an o/w emulsion comprising
(1) a continuous aqueous phase; and
(2) a dispersed phase in form of droplets dispersed in the continuous phase, wherein each droplet is at least partially coated with at least one chitosan and comprises at least one emulsifier, at least one agricultural active and optionally at least one carrier (oil).

In various embodiments, the at least one agricultural active has pesticidal and/or plant stimulating activity. The at least one agricultural active may for example be selected from the group consisting of plant extracts, plant-derived molecules or mixtures thereof but may also be a chemically synthesized or non-natural active. In various embodiments, the at least one agricultural active is a fungicide, an insecticide, a herbicide, a bactericide, a nematicide, and/or a plant growth regulator, for example a fungicide.

In various embodiments, the at least one agricultural active is selected from synthetic (types of) compounds or mixtures of synthetic compounds such as known fungicides. Examples include, without limitation, aminopyridines such as fluazinam, anilinopyrimidines such as cyprodinil, benzamides such as fluopyram, conazoles such as epoxiconazole and hexaconazole, dioxazines such as fluoxastrobin, imidazoles such as imazalil, morpholines such as dimethomorph and fenpropidine, phenylpyrroles such as fludioxonil, phthalonitriles such as chlorothalonil, pyrazoles such as benzovindiflupyr, bixafen, fluxapyroxad and penthiopyrad, pyridinecarboxamides such as boscalid, pyrimidines such as bupirimate, strobilurins such as azoxystrobin, trifloxystrobin and pyraclostrobin, triazoles such as tebuconazole and metconazole.

In various embodiments, the at least one agricultural active may be an insecticide, for example selected from the group consisting of benzoyl ureas such as novaluron, lufenuron, chlorfluazuron, flufenoxuron, hexaflumuron, noviflumuron, teflubenzuron, triflumuron and diflubenzuron; carbamates; pyrethroids such as cyhalothrin and isomers and isomer mixtures thereof, lambda-cyhalothrin, deltamethrin, tau-fluvalinate, cyfluthrin, beta-cyfluthrin, tefluthrin, and, bifenthrin; organophosphates such as azinfos-methyl, chlorpyrifos, diazinon, endosulfan, methidathion; neonicotinoids, and phenylpyrazoles such as imidacloprid, acetamiprid, thiacloprid, dinotefuran, thiamethoxam and fipronil.

In various embodiments, the at least one agricultural active may be a nematicide, for example fluopyram, fluensulfone, 1,3-dichloropropene, abamectin, emamectin benzoate, fenamiphos and/or azadirachtin.

In various embodiments, the at least one agricultural active may be a herbicide, for example selected from the group consisting of aryloxyphenoxy derivatives, aryl ureas, aryl carboxylic acids, aryloxy alkanoic acid derivatives such as clodinafop-propargyl and analogues thereof, fenoxaprop-p-ethyl and analogues thereof, propaquizafop, quizalafop and analogues thereof, dinitroanilines such as pendimethalin and trifluralin; diphenyl ethers such as oxyfluorfen, imidazolinones, sulfonylureas such as chlorsulfuron, nicosulfuron, rimsulfuron, tribenuron-methyl, sulfonamides, triazines, and triazinones such as metamitron.

In various embodiments, the at least one agricultural active is selected from the group of essential oils, individual components of essential oils, and mixtures thereof. The essential oil may, without limitation, be selected from the group consisting of allspice oil, ambrette seed oil, amyris oil, Angelica root oil, anise oil, anthopogon oil, arborvitae oil, basil oil, bay laurel oil, beeswax absolute, bergamot oil, bergamot mint oil, bitter orange oil, black pepper oil, black spruce oil, blood orange oil, blue cypress oil, blue spruce oil, blue tansy oil, bois de rose oil, Boronia absolute, Bursera graveolens oil, cade oil, cajeput oil, camphor oil, Cananga oil, Cannabis oil, cardamom oil, carrot seed oil, Cassia oil, castor oil, catnip oil, cedar oil, chamomile oil, cilantro oil, cinnamon oil, Cistus oil, Citrus oil, citronella oil, clary sage oil, clove oil, coffee oil, common sage oil, copaiba balsam oil, coriander oil, corn oil, cornmint oil, cottonseed oil, cubeb oil, cumin oil, cypress oil, davana oil, dill oil, elemi oil, Eucalyptus oil, fennel oil, fir oil, fragonia oil, frankincense oil, Galbanum oil, garlic oil, geranium oil, ginger oil, goldenrod oil, grapefruit oil, greenland moss oil, gurjum balsam oil, helichrysum oil, hemp oil, hinoki oil, ho oil, hops oil, hyssop oil, ishpingo oil, lavender oil, jasmin oil, juniper oil, Kunzea oil, laurel oil, lavandin oil, lavender oil, ledum oil, lemon oil, lemon balm oil, lemon Eucalyptus oil, lemongrass oil, lemon myrtle oil, lemon tea tree oil, lemon Verbena oil, lime oil, linden oil, linseed oil, mandarin oil, manuka oil, marjoram oil, may chang oil, melissa oil, mint oil, myrrh oil, myrtle oil, neem oil, neroli oil, niaouli oil, nutmeg oil, oakmoss oil, onion oil, opoponax oil, orange oil, oregano oil, palmarosa oil, palo santo oil, parsley oil, patchouli oil, peppermint oil, pink pepper oil, peru balsam oil, petitgrain oil, pimento oil, pine oil, plai oil, pomelo oil, Rhododendron oil, Rosalina oil, rose oil, rosemary oil, rosewood oil, sage oil, sandalwood oil, saro oil, Sassafras oil, spearmint oil, spikenard oil, spruce oil, star anis oil, Styrax benzoin absolute, sweet orange oil, Tagetes oil, tangerine oil, tea tree oil, thyme oil, tobacco oil, tuberose oil, tulsi oil, valerian oil, vanilla oil, vetiver oil, violet oil, white tea tree oil, wintergreen oil, xanthoxylum oil, yarrow oil, ylang ylang oil, yuzu oil, mixtures thereof, and individual components thereof.

Examples for suitable individual components of an essential oil include, without limitation, those selected from the group of (+/−)-bornyl acetate, (+/−)-carveol, (+/−)-caryophyllene oxide, (+/−)-citronellal, (+/−)-dihydrocarvyl acetate, (+/−)-fenchone, (+/−)-isopinocampheol, (+/−)-isopulegol, (+/−)-menthone, (+/−)-menthyl acetate, (+/−)-myrtenol, (+/−)-perillylalcohol, (+/−)-trans-myrtanol, (+/−)-verbenone, (+)-2-carene, (+/−)-cuparene, (+/−)-dihydrocarveol, (+/−)-dihydrocarvone, (+/−)-isomenthol, (+/−)-borneol, (+/−)-alpha-pinene, (+/−)-beta-pinene, (+/−)-beta-citronellol, (+/−)-camphor, (+/−)-linalool, (+/−)-menthol, (+/−)-neomenthol, (1R)-chrysanthemolactone, (1 S,2S)-10-pinanol, (cis/trans)-nerolidol, 1,4-cineole, 1,8-cineole, 2-isopropyl-5-methylphenol (thymol), 2-norbornanone, 3-carene, 3-octanone, 4-menthan-3-one, acetic acid butylester, 2-phenylethyl propionate, acetic acid cinnamylester, acetic acid heptylester, acetic acid isobutylester, acetic acid methylester, alpha-(−)-bisabolol, alpha-caryophyllene, alpha-cedrene, alpha-humulene, alpha-ionone, alpha-terpinene, alpha-terpineol, azulene, benzoic acid eugenylester, beta-cedrene, beta-naphthol, beta-thujaplicin, butyl acetate, cajeputol, camphene, cedar camphor, cedrol, chamazulen, cinnamyl acetate, cis-jasmone, cis-nerolidol, citral, citronellol, cuminaldehyde, cypress camphor, dihydrocarveol, dillapiole, DL-citronellyl acetate, estragole, eucalyptol, eugenol methylether, eugenylbenzoate, exo-2-camphanol, farnesol, furfuryl acetate, furfuryl alcohol, gamma-terpinene, geranyl acetate, geraniol, heptyl acetate, isobornyl acetate, isobornyl isovalerate, isobutyl acetate, isocineole, isoeugenol, isoeugenylacetate, isolongifolene, isomenthone, isothymol, lemonol, linalool oxide, linalyl acetate, nerol, nootkatone, p-allylanisole, piperitone, R-(−)-alpha-phellandrene, R-(+)-limonene, R-(+)-pulegone, S-(−)-limonene, sabinene, sabinyl acetate, terpinolene, terpinyl acetate, tetrahydrolinalool, trans-nerolidol, trans-stilbene, eugenol, and lavendulol.

In various embodiments, the at least one chitosan is selected from chitosan polymers and/or polymer-oligomer mixture with random or non-random pattern of acetylation (PA) and mixtures thereof. The chitosan may have antimicrobial and/or plant stimulating activity on its own.

The at least one chitosan may, in various embodiments, be selected from those that have
a degree of acetylation (DA) of up to 30, preferably 10 to 30; and/or
a degree of polymerization (DP) of up to 5000, preferably up to 1200; and/or
an average molecular weight Mw of <900.000 g/mol, optionally <200.000 g/mol.

In various embodiments, the at least one chitosan has a DA of up to 30, preferably 10 to 30, a DP of up to 5000, preferably up to 1200, and a Mw of <900.000 g/mol, optionally <200.000 g/mol.

In various embodiments where the at least one chitosan is a chitosan polymer or a mixture of chitosan polymers and oligomers, the chitosan polymers and oligomers independently of each other have a degree of acetylation (DA) of up to 30, preferably 10 to 30, the chitosan polymers have a Mw of 40.000 to 100.000 g/mol, preferably 50.000 to 80.000 g/mol, more preferably 55.000 to 65.000 g/mol and the chitosan oligomers have a degree of polymerization (DP) of 2 to 30, for example a molecular weight in the range of 360 to 6.000 g/mol.

In various embodiments, the at least one emulsifier is selected from the group consisting of monoglycerides, sorbitan esters, alkylene glycol esters such as propylene glycol esters, phospholipids such as lecithins, polysorbates, sucrose esters of medium chain saturated fatty acids, sucrose esters of long chain saturated fatty acids, and sucrose esters of unsaturated fatty acids.

The chitosan-coated emulsion may comprise at least one carrier, such as a carrier oil, selected from the group consisting of synthetic or natural oils comprising free fatty acids, mono-, di- and triglycerides, fatty acid ethyl esters, or a combination thereof.

The plant treatment composition may be an emulsion concentrate or a ready-to-use emulsion.

The emulsion may comprise the at least one chitosan in an amount of from 0.001 to 50% (w/w), preferably in an amount of 0.005 to 10% (w/w), more preferably in an amount of 0.01 to 1% (w/w) relative to the total weight of the emulsion.

The at least one emulsifier may be comprised in the emulsion in an amount of from 0.001 to 50% (w/w), preferably in an amount of 0.005 to 10% (w/w), more preferably in an amount of 0.01 to 5% (w/w) relative to the total weight of the emulsion.

In various embodiments, the plant treatment composition wherein the chitosan-coated emulsion comprises at least one carrier (oil) in an amount of from 0.0001 to 95% (w/w), preferably in an amount of 0.001 to 70% (w/w), more preferably in an amount of 0.01 to 50% (w/w) relative to the total weight of the emulsion.

The at least one agricultural active may be comprised in an amount of from 0.0001 to 90% (w/w), preferably in an amount of 0.001 to 70% (w/w) more preferably in an amount of 0.01 to 50% (w/w), relative to the total weight of the emulsion.

In various embodiments, the plant treatment composition is an agricultural composition, a horticultural composition, a silvicultural composition or a pesticide composition.

In another aspect, the invention is directed to the use of the plant treatment composition as disclosed herein as a plant biostimulant, antimicrobial agent, biopesticide and/or preservative in agricultural, horticultural and/or silvicultural applications.

In still another aspect, the invention relates to the use of the plant treatment composition as described herein for the control of pests in a plant.

A still further aspect of the invention features a method for controlling pests in crops, comprising applying the plant treatment compositions as disclosed herein to any part of the plant, the soil in which the plant is growing or is intended to grow or the seeds of the plant or to a plant/seed/fruit for post-harvest protection.

The invention also encompasses a method for stimulating the growth or health of a plant, comprising applying the plant treatment composition as disclosed herein to any part of the plant, the soil in which the plant is growing or is intended to grow or the seeds of the plant.

In various embodiments of the methods and uses disclosed, the pest is a plant pathogenic fungus or fungus-like organisms such as a plant pathogenic oomycete, a plant pathogenic bacterium or bacterium-like organisms such as a plant pathogenic phytoplasma, a plant pathogenic virus or virus-like particle such as a plant pathogenic viroid, or a plant pathogenic invertebrate, such as a plant pathogenic insect or a plant pathogenic nematode.

In various embodiments, the fungus may, without limitation, be selected from the group consisting of Alternaria spp., Blumeria spp., Boeremia spp., Botrytis spp., Bremia spp., Cercospora spp., Cladobotryum spp., Cladosporium spp., Claviceps spp., Colletotrichum spp., Didymella spp., Erysiphe spp., Fusarium spp., Hemileia spp., Hyaloperonospora spp., Magnaporthe spp., Melampsora spp., Microdochium spp., Monilinia spp., Mycosphaerella spp., Neofabraea spp., Oculimacula spp., Penicillium spp., Peronospora spp., Phakopsora spp., Phomopsis spp., Phytophthora spp., Pilidiella spp., Plasmopara spp., Pseudoperonospora spp., Puccinia spp., Pyrenochaeta spp., Pyrenopeziza spp., Pyrenophora spp., Ramularia spp., Rhizoctonia spp., Sclerospora spp., Sclerotinia spp., Septoria spp., Sphaerotheca spp., Stagonosporopsis spp., Stemphylium spp., Taphrina spp., Ustilago spp., Venturia spp. and Verticillium spp.

In various embodiments, the fungus may, without limitation, be selected from the group consisting of: Alternaria alternata, Alternaria brassicicola, Alternaria citri, Alternaria dauci, Alternaria solani, Alternaria tomatophila, Blumeria graminis, Boeremia exigua, Botrytis calthae, Botrytis cinerea, Botrytis fabae, Botrytis pelargonii, Botrytis pseudocinerea, Bremia lactucae, Cercospora beticola, Cladobotryum mycophilum, Cladosporium fulvum, Claviceps purpurea, Colletotrichum acutatum, Colletotrichum capsici, Colletotrichum coccodes, Colletotrichum destructivum, Colletotrichum gloeosporioides, Colletotrichum lindemuthianum, Colletotrichum orbiculare, Didymella pinodes, Erysiphe cichoracearum, Fusarium avenaceum, Fusarium culmorum, Fusarium graminearum, Fusarium oxysporum, Fusarium sambucinum, Fusarium solani, Fusarium udum, Fusarium verticillioides, Hemileia vastatrix, Hyaloperonospora parasitica, Magnaporthe oryzae, Melampsora lini, Microdochium majus, Monilinia fructicola, Monilinia laxa, Monilinia polystroma, Monilinia vaccinii-corymbosi, Mycosphaerella graminicola, Neofabraea vagabunda, Oculimacula acuformis, Oculimacula yallundae, Penicillium digitatum, Penicillium expansum, Penicillium italicum, Peronospora viciae, Phakopsora pachyrhizi, Phomopsis cucurbitae, Phomopsis obscurans, Phomopsis viticola, Phytophthora infestans, Phytophthora syringae, Pilidiella granati, Plasmopara halstedii, Plasmopara viticola, Pseudoperonospora cubensis, Puccinia graminis, Puccinia hordei, Puccinia melanocephala, Puccinia polysora, Puccinia recondita, Puccinia sorghi, Puccinia striiformis, Puccinia triticina, Pyrenochaeta lycopersici, Pyrenopeziza brassicae, Pyrenophora teres, Ramularia collo-cygni, Ramularia necator, Rhizoctonia solani, Sclerospora graminicola, Sclerotinia sclerotiorum, Septoria apiicola, Sphaerotheca fuligina, Stagonosporopsis cucurbitacearum, Stemphylium vesicarium, Taphrina deformans, Ustilago hordei, Ustilago maydis, Ustilago tritici, Venturia inaequalis, Verticillium albo-atrum and Verticillium dahlia.

In various embodiments, the bacterium may, without limitation, be selected from the group consisting of: Acidovorax spp., Acidovorax spp., Agrobacterium spp., Ca. Liberibacter spp., Ca. Phytoplasma spp., Clavibacter spp., Curtobacterium spp., Dickeya spp., Erwinia spp., Pantoea spp., Pectobacterium spp., Pseudomonas spp., Ralstonia spp., Streptomyces spp., Xanthomonas spp., Xylella spp. and Xylophilus spp.

In various embodiments, the bacterium may, without limitation, be selected from the group consisting of: Acidovorax avenae, Acidovorax citrulli, Agrobacterium tumefaciens, Ca. Liberibacter africanus, Ca. Liberibacter americanus, Ca. Liberibacter asiaticus, Ca. Liberibacter solanacearum, Ca. Phytoplasma americanum, Ca. Phytoplasma mali, Ca. Phytoplasma phoenicium, Ca. Phytoplasma pruni, Ca. Phytoplasma pyri, Ca. Phytoplasma solani, Ca. Phytoplasma ulmi, Citrus huanglongbing, Clavibacter michiganensis, Coconut lethal yellowing phytoplasma, Curtobacterium flaccumfaciens, Dickeya dadantii, Dickeya dianthicola, Dickeya solani, Dickeya zeae, Erwinia amylovora, Erwinia carotovora, Erwinia chrysanthemi, Erwinia stewartii, Grapevine flavescence doree phytoplasma, Pantoea stewartii, Peach rosette phytoplasma, Peach yellows phytoplasma, Pectobacterium atrosepticum, Pectobacterium brasiliense, Pectobacterium carotovorum, Pectobacterium parmentieri, Pseudomonas avenae, Pseudomonas syringae, Ralstonia pseudosolanacearum, Ralstonia solanacearum, Ralstonia solanacearum, Ralstonia syzygii, Streptomyces scabiei, Xanthomonas albilineans, Xanthomonas arboricola, Xanthomonas axonopodis, Xanthomonas campestris, Xanthomonas citri, Xanthomonas cynarae, Xanthomonas euvesicatoria, Xanthomonas fragariae, Xanthomonas hortorum, Xanthomonas oryzae, Xanthomonas phaseoli, Xanthomonas translucens, Xanthomonas vesicatoria, Xylella fastidiosa and Xylophilus ampelinus.

In various embodiments, the nematode may, without limitation, be selected from the group consisting of: Aphelenchoides spp., Anguina spp., Belonolaimus spp., Ditylenchus spp., Globodera spp., Heterodera spp., Meloidogyne spp., Nacobbus spp., Pratylenchus spp., Radopholus spp., Rotylenchulus spp. and Tylenchulus spp., Xiphinema spp.

In various embodiments, the nematode may, without limitation, be selected from the group consisting of: Aphelenchoides besseyi, Anguina tritici, Belonolaimus longicaudatus, Ditylenchus angustus, Ditylenchus dipsaci, Ditylenchus africanus, Ditylenchus destructor, Globodera pallida, Globodera rostochiensis, Heterodera avenae, Heterodera cruciferae, Heterodera filipjevi, Heterodera glycines, Heterodera schachtii, Meloidogyne arenaria, Meloidogyne chitwoodi, Meloidogyne fallax, Meloidogyne graminicola, Meloidogyne hapla, Meloidogyne incognita, Meloidogyne javanica, Nacobbus aberrans, Nacobbus dorsalis, Nacobbus serendipiticus, Pratylenchus brachyurus, Pratylenchus coffeae, Pratylenchus neglectus, Pratylenchus penetrans, Pratylenchus thornei, Pratylenchus vulnus, Pratylenchus zeae, Radopholus similis, Rotylenchulus reniformis, Rotylenchulus parvus, Tylenchulus semipenetrans, Xiphinema americanum, Xiphinema diversicaudatum, Xiphinema index and Xiphinema vuittenezi.

In various embodiments, insect pests may, without limitation belong to the order such as Diptera (flies), Lepidoptera (butterflies and moths), Coleoptera (beetles), Hemiptera (true bugs, aphids), Orthoptera (grasshoppers, crickets, and katydids), Hymenoptera (sawflies, wasps).

Some more specific examples of insect pests without limitation encompass aphids (e.g green peach aphid (family: Aphididae), balsam woolly adelgid (family: Adelgidae), grape Phylloxera (family: Phylloxeridae)), scale insects (e.g. cottony cushion scales (family: Monophlebidae), soft scales (family Coccidae)), whiteflies (e.g. cabbage whitefly, greenhouse whitefly (family Aleyrodidae)), armyworms (e.g. fall army worm, true army worm, beet armyworm, pale western cutworm, army cutworm, bertha armyworm (family: Noctuidae)), beetles (e.g. colorado potato beetle, asparagus beetle (family: Chrysomelidae), sunflower headclipping weevil (family: Attelabidae), cabbage seedpod weevil, pea leaf weevil (family: Curculionidae)), true bugs (e.g. false chinch bug (family: Lygaeidae), black grass bugs (family: Miridae)), caterpillars (e.g. european corn borer (family: Pyralidae), stalk borers (family: Crambidae), cabbage moth (family: Geometridae), corn earworm moth (family: Noctuidae)), mites (e.g. spider mites (family: Tetranychidae), thread-footed mites (family: Tarsonemidae), and the gall mites (family Eriophyidae)), Thrips (e.g. onion Thrips (family: Thripidae), western flower Thrips (family: Aeolothripidae), banded flower Thrips (family: Phlaeothripidae)), sawflies (e.g. wheat stem sawfly (family: Cephidae)), flies (e.g. wheat midge (family Cecidomyiidae), cherry fruit flies (family: Tephritidae)).

In various embodiments, the plant is an agricultural plant, vegetable or fruit, optionally wheat, barley, oat, rye, soybean, corn, potatoes, oilseed rape, canola, sunflower, cotton, sugar cane, sugar beet, rice, apple, walnut, pea, Ioquat, Narcissus, cucumber, apricot, plum, peach, beans, mushrooms, grapevine, Dianthus, Citrus fruit, spinach, lettuce, tomato, asparagus, cabbages, sorghum, pear, strawberry, sweet pepper, carrot, onion, celery, blackberry, linseed, or leek; a silvicultural plant; an ornamental plant; or a horticultural plant.

In a still further aspect, the invention is directed to a method for the preparation of a chitosan-coated o/w (oil-in-water) emulsion, said chitosan-coated emulsion comprising an aqueous continuous phase and a non-aqueous dispersed phase, wherein the dispersed phase is in the form of droplets dispersed in the continuous phase, said droplets being at least partially coated with at least one chitosan, the method comprising the steps of:
a) providing an aqueous phase comprising said at least one chitosan,
b) providing an organic phase comprising at least one water-miscible organic solvent, at least one emulsifier, at least one agricultural active and optionally at least one carrier (oil),
c) emulsifying the organic phase in the aqueous phase, and
d) optionally, reducing the volume of the emulsion obtained in step c) to about 25% to 80% of its original volume, optionally by means of evaporation.

In various embodiments of the above method, the chitosan is comprised in an amount of from 0.001 to 50% (w/w), 0.005 to 10% (w/w), or 0.01 to 1% (w/w) relative to the total weight of the emulsion, or 0.01 to 5% (w/v), or 0.02 to 1% (w/v), or 0.05 to 0.5% (w/v) in the aqueous phase of step a).

The aqueous phase in step a) may comprise glycerol, optionally in an amount of from 10 to 50% (v/v).

In various embodiments of these methods, the at least one emulsifier is comprised in an amount of from 0.001 to 50% (w/w), 0.005 to 10% (w/w), or 0.01 to 5% (w/w) relative to the total weight of the emulsion, or 0.05 to 2% (w/v), or 0.1 to 1% (w/v), or 0.2 to 0.8% (w/v) in the organic phase in step b).

The at least one water-miscible organic solvent may be selected from the group consisting of monohydric alcohols such as methanol, ethanol, propanol, isopropanol, n-butanol and t-butanol; dihydric alcohols such as glycols such as propylene glycol, ethylene glycol, tetraethylene glycol, triethylene glycol, trimethylene glycol; trihydric alcohols such as glycerin, butane-1,2,3-triol, pentane-1,3,5-triol, 2-amino-2-hydroxymethyl-propane-1,3-diol; and other alcohols as well as mixtures thereof. It may be present in an amount of from 99 to 30% (v/v), preferably in an amount of 96 to 50% (v/v), more preferably in an amount of 93 to 80% (v/v) in the organic phase of step b).

In various embodiments, the at least one carrier (oil) is comprised in an amount of from 0.0001 to 95% (w/w), 0.001 to 70% (w/w), or 0.01 to 50% (w/w) relative to the total weight of the emulsion, or 0.01 to 5% (v/v), or 0.2 to 2% (v/v), or 0.5 to 1.5% (v/v) in the organic phase in step b).

In step d), the volume of the emulsion may be reduced to about 25% to 55% of its original volume. In such embodiments, the chitosan may be present in an amount of from 0.02 to 0.5% (w/v), preferably in an amount of 0.05 to 0.2% (w/v) in the aqueous phase in step a); and/or the emulsifier may be present in an amount of from 0.05 to 2% (w/v), preferably in an amount of 0.2 to 0.8% (w/v) in the organic phase in step b).

In other embodiments, in step d), the volume of the emulsion is reduced to about 55% to 80% of its original volume. In such embodiments, the chitosan may be present in an amount of from 0.05 to 0.8% (w/v), preferably in an amount of 0.1 to 0.4% (w/v) in the aqueous phase in step a); and/or the emulsifier is present in an amount of from 2 to 10% (w/v), preferably in an amount of 4 to 8% (w/v) in the organic phase in step b).

In various embodiments, the at least one agricultural active is present in an amount of from 0.0001 to 90% (w/w), 0.001 to 70% (w/w), 0.01 to 50% (w/w) relative to the total weight of the emulsion, or 0.5 to 50% (v/v) or 1 to 8% (v/v) in the organic phase of step b).

In a still further embodiments, the invention also covers a chitosan-coated emulsion obtainable/obtained by a method as disclosed herein. Also encompassed are plant treatment compositions comprising a chitosan-coated emulsion obtainable/obtained by a method as disclosed herein.

### BRIEF DESCRIPTION OF THE FIGURES

FIG. 1 shows the results of the physicochemical characterization of formulations with different v/v % of peppermint oil (PO). Shown are their average hydrodynamic diameter and polydispersity (both a), their zeta potential (b), and their derived count rate (c). Given are the mean values (±standard deviations) of three (1-CS1_3PO), two (1-CS1_4-6PO), or one (1-CS1_10PO) independent preparation. Chitosan: CS1 (DA 20%, Mw 136 kDa; 0.1% (w/v)). Formulations are prepared using method 1.

FIG. 2 shows the results of the physicochemical characterization of formulations with 3% (v/v) peppermint oil (PO) and different type of chitosans at 0.1% (w/v). Shown are the average hydrodynamic diameter and polydispersity (both a), the zeta potential (b), and the derived count rate (c). Given are the mean values (±standard deviations): 1-CS1_3PO: N=3, n=3; 1-CS2_3PO and 1-CS3_3PO: N=1, n=3. Chitosans: CS1 (DA 20%, Mw 136 kDa); CS2 (DA 20%, Mw 60 kDa); CS3 (DA 30%, Mw 145 kDa). Formulations are prepared using method 1.

FIG. 3 shows the results of the physicochemical characterization of formulations with 3% (v/v) peppermint oil (PO) at different concentrations of chitosan CS1 (DA 20%, Mw 136 kDa; 0.1%, 0.2%, and 0.4% (w/v)). Shown are the average hydrodynamic diameter and polydispersity (both a), the zeta potential (b), and the derived count rate (c). Given are the mean values (±standard deviations) of three measurements (N=1). Formulations are prepared using method 1.

FIG. 4 shows the results of the physicochemical characterization of formulations prepared with chitosan CS1 (DA 20%, Mw 136 kDa; 0.2% (w/v)) and different lipophilic molecules in the core (3% (v/v)): peppermint oil (PO), spearmint (SP), geraniol (GR) with glycerol, eugenol (EU) in miglyol, thymol (TH) in miglyol and clove oil (CO). Shown are the average hydrodynamic diameter and polydispersity (both a), the zeta potential (b), and the derived count rate (c). Given are the mean values (±standard deviations) of three independent experiments. Formulations are prepared using method 2.

FIG. 5 shows the results of the physicochemical characterization of selected formulations prepared with chitosan CS1 (DA 20%, Mw 136 kDa; 0.2% (w/v)) and different lipophilic molecules in the core (3% (v/v)): peppermint oil (PO), spearmint (SP), geraniol (GR) with glycerol, clove oil (CO), eugenol (EU) in miglyol and thymol (TH) in miglyol. The formulations were stored at 4 °C and room temperature (RT) for three months (t0=freshly prepared; t1=one month; t2=two months; t3=three months).

Shown are the average hydrodynamic diameter and polydispersity (both a), the zeta potential (b), and the derived count rate (c). Given are the mean values (±standard deviations) of three measurements (N=1). Formulations are prepared using method 2.

FIG. 6 depicts the encapsulation of chitosan-stabilized formulations containing a core of (e.g. essential oils). Schematic structure of a particle (a). Transmission electron microscopy image of the formulation 2-CS1_3PO, as prepared by method 2 (b).

FIG. 7 shows the results obtained in terms of antifungal activity of chitosan-stabilized formulations against F. graminearum performed in a 96-well plate (liquid assay). Comparison of formulations with 3% (v/v) peppermint oil (PO) with different chitosan concentrations (CS1: 0.1%, 0.2% and 0.4% (w/v)) (a), comparison of formulations with 3% (v/v) peppermint oil and different types of chitosans (CS1, CS2 and CS3 at 0.1% (w/v)) (b), and the comparison of formulations with 3% and 6% (v/v) peppermint oil (c). Shown are the mean values (±standard deviations) of N=9, n=6 for 1-CS1_3PO, N=2, n=6 for 2-CS1_3PO, 1-CS2_3PO, 1-CS1_6PO and N=1, n=6 for 4-CS1_3PO, 1-CS3_3PO. Chitosans: CS1 (DA 20%, Mw 136 kDa); CS2 (DA 20%, Mw 60 kDa); CS3 (DA 30%, Mw 145 kDa). Formulations are prepared with method 1.

FIG. 8 shows the bioactivity of different formulations against F. graminearum (above) and B. cinerea (below) stored for 3 months at room temperature (RT (t3_RT)) and at 4 °C (t3_4 °C) compared to freshly prepared samples (t0). All formulations were prepared with 0.2% (w/v) chitosan CS1 (DA 20%, Mw 136 kDa) and 3% (v/v) of the respective oil. PO=peppermint, SP=spearmint, GR=geraniol with glycerol, CO=clove oil, EU=eugenol in miglyol, TH=thymol in miglyol. Shown are the mean values (±standard deviations) of three independent experiments. Formulations were prepared with method 2.

FIG. 9 shows light-microscopy images of F. graminearum showing macroconidia germination, germ tube, and hyphal development of non-treated macroconidia (H₂O) and conidia treated with chitosan-stabilized clove oil formulation 2-CS1_3CO, the corresponding emulsion E_3CO and chitosan 2-CS1 (DA 20%, Mw 136 kDa) in different dilutions (1:100, 1:200 and 1:500). The macroconidia were incubated for 24 h in CM-medium. The arrows indicate the presence of macroconidia in the image. Formulations are prepared using method 2.

FIG. 10 shows the results obtained in terms of antibacterial activity of chitosan-stabilized formulations against P. syringae performed in 96-well plate (liquid assay). Comparison of formulations with 3% (v/v) peppermint oil (PO) and different chitosan concentrations (CS1: 0.1%, 0.2% and 0.4% (w/v)) (a), comparison of formulations with 3% (v/v) peppermint oil and different chitosan types (CS1 and CS2 at 0.1% (w/v)) (b), and comparison of formulations with 3% and 6% (v/v) peppermint oil (c). Shown are the mean values (±standard deviations): N=2, n=3 for 1-CS1_3PO and 1-CS1_6PO; N=1, n=3 for 2-CS1_3PO and 4-CS1_3PO; N=3, n=3 for 1-CS2_3PO. Chitosans: CS1 (DA 20%, Mw 136 kDa); CS2 (DA 20%, Mw 60 kDa). Formulations are prepared with method 1.

FIG. 11 shows the results obtained in terms of nematicide activity of chitosan-stabilized formulation with peppermint oil 3% (v/v) (a) and 6% (v/v) (b) against the plant parasitic nematode M. incognita. Shown are the mean values (n=4) from one representative experiment. Chitosans: CS1 (DA 20%, Mw 136 kDa; 0.1% (w/v)); CS2 (DA 20%, Mw 60 kDa; 0.1% (w/v)). Formulations are prepared with method 1.

FIG. 12 shows the nematicide activity of 2-CS1-3PO against the nematodes M. hapla and M. chitwoodi in comparison to an external formulation containing chitosan and PO. Shown are the mean values (n=4) (±standard deviations) of one experiment. CS1 (DA 20%, Mw 136 kDa; 0.2% (w/v)). Formulations are prepared with method 2.

FIG. 13 shows the eliciting activity of chitosan-stabilized formulations with varying chitosan types (CS1: DA 20%, Mw 136 kDa; CS2: DA 20%, Mw 60 kDa; 0.2% (w/v)) containing miglyol (medium chain triglyceride oil, M). Leaf discs from 6-week-old potato plants (Solanum tuberosum cv. Sarpo mira) were used for the assay. Shown are the mean values of the relative light units over time (N=1, n=4) (a). Maximum of the oxidative burst given in relative light-units from three independent experiments normalized to the water control (N=3; n=4). Stars indicate a significant difference to the water control at **p<0.01 and ***p<0.001 (ANOVA, Tukey test).

FIG. 14 shows the expected and observed inhibition of four different chitosan-stabilized formulations containing varying plant-based lipophilic ingredients against F. graminearum: 1-CS1_6PO (a) and 1-CS2_6PO (b) prepared with chitosan CS1 and CS2 and peppermint oil (PO) using method 1, 2-CS2_3GR prepared with CS2 and geraniol in miglyol (GR) using method 2 (c) and 2-CS2_3EU prepared with CS2 and eugenol (EU) in miglyol using method 2 (d). Fungal growth was measured by UV-Vis spectrophotometer at 600 nm (OD600) after 4 days of incubation in a 96-well microtiter plate. Expected inhibition was calculated using Abbott's formula. Data shown are mean values±SD of N=2-3, n=6. Chitosans: CS1 (DA 20%, Mw 136 kDa; 0.1% (w/v)); CS2 (DA 20%, Mw 60 kDa; 0.1% (w/v)).

FIG. 15 shows the in vivo activity of chitosan-stabilized clove oil formulation 2-CS1_CO containing 3% (v/v) clove oil (CO) and 0.2% (w/v) chitosan CS1 (DA 20%, Mw 136 kDa) in comparison to the corresponding emulsion E_CO and chitosan 2-CS1. Leaf discs were punched out from 12 days old bean plants (Phaseolus vulgaris, 8 leaf discs from 3-4 plants per treatment), placed on water agar plates, and inoculated with B. cinerea by placing a 7 μL spore solution droplet (10.000 spores/mL) in the center of the leaf disc. The sealed plates were incubated at 21 °C and 1 dpi the leaf discs were treated by spraying the treatment solutions at different dilutions (1:10; 1:20; 1:50; 1:100) on the disc surface. The results were obtained at 4 dpi. A representative set of leaf discs at 4 dpi is shown (a). The disease incidence reflects the number of infected leaf discs in percentage. Given are the mean values of three independent experiments, diamonds indicate the disease incidence from single experiments (b). The disease severity was assessed by measuring the necrotic area and normalized to the water control. The disease severity includes only infected leaf discs. Therefore, no data is available for non-infected groups and are indicated as N/A=not available. Given are the mean values (open squares) of three independent experiments (N=3, n=8) and diamonds indicate the disease severity from infected leaf discs (c). Formulations were prepared using method 2.

### DETAILED DESCRIPTION

Unless otherwise defined, all terms of art, notations and other scientific terminologies used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. The techniques and procedures described or referenced herein are generally well understood and commonly employed using conventional methodology by those skilled in the art. As appropriate, procedures involving the use of commercially available kits and reagents are generally carried out in accordance with manufacturer defined protocols and/or parameters unless otherwise noted.

The term “emulsion”, as used in the present invention and in line with the common meaning in the art, refers to a composition containing a mixture of non-miscible liquid components homogenously blended together. Particularly, an emulsion is understood to be a preparation of one liquid distributed in small globules or droplets throughout the body of a second liquid. The dispersed liquid is the discontinuous phase, and the dispersion medium is the continuous phase. If oil is the dispersed liquid and an aqueous solution is the continuous phase, the emulsion is a so-called oil-in-water (o/w) emulsion, whereas when water or aqueous solution is the dispersed phase and oil or an oil-like/hydrophobic substance is the continuous phase, the emulsion is a water-in-oil (w/o) emulsion. The emulsions disclosed herein are o/w emulsions, i.e. the dispersed phase is the hydrophobic/lipophilic/oil phase.

The term “chitosan-coated emulsion” as used in the context of the present invention refers to an emulsion, wherein the individual droplets/globules of the dispersed, discontinuous phase are at least partially coated with chitosan, i.e., the outer surface of the individual droplets/globules of the discontinuous phase have a chitosan coating. In the context of the present invention, a “chitosan-coated emulsion” may also be referred to as a “chitosan-stabilized emulsion”. Due to its specific properties, chitosan arranges itself at the interface between oil and water phases and thus forms a protective shell around the oil droplets.

The term “at least partially” as used herein refers to a fraction of the totality that is given as a minimum value, for example more than 60%, preferably more than 70%, more than 80% or more than 90% of the respective object in relation to the totality of said object. With respect to the “at least partial coating” of the droplets of the discontinuous phase of the emulsion of the present invention, said term means that embodiments in which only part of the droplet surface is coated by chitosan molecules are also covered. In various embodiments, more than 10%, more than 20%, more than 30%, more than 40%, more than 50%, more than 60%, more than 70%, more than 80% or more than 90% of the outer surface of an individual droplet/globule in relation to the total outer surface of the same individual droplet/globule is coated with the at least one chitosan. The extent of the coating of the droplets can be adjusted by the chitosan concentration, with higher concentrations relative to the oil phase resulting in a more complete coating. If the chitosan concentration is high enough a complete coating that forms a shell-like structure around the oil core is formed. It is understood that such a shell may still be a dynamic structure as the individual chitosan molecules are not covalently linked and may still be permeable for various molecules.

The term “non-random”, as used in the present invention in relation to the pattern of acetylation of the chitosans, defines the pattern of acetylation that may be generated by various methods, for example an enzymatic process. The term “non-random” means that the pattern of acetylation of the chitosan is predictable and reproducible for determined process conditions and follows a non-Bernoulli distribution. As the process conditions might be slightly modified or vary, the same process (for example using the same enzyme) typically still leads to the same or essentially the same chitosan acetylation pattern. In processes where non-random acetylation patterns are obtained, usually enzymes are used to facilitate the acetylation or deacetylation process. In the art enzymes are known that recognize and create specific acetylation patterns and thus produce a molecule in which the acetylation pattern is non-random. Nevertheless, slight modifications in the chitosan pattern may still occur when reproducing a same process leading to essentially the same chitosan, for example, leading to chitosans with acetylation patterns having at least 90%, preferably at least 95%, more preferably at least 98% identity with each other. In other words, a non-random chitosan (i.e., a chitosan with a non-random pattern of acetylation) is obtained in a reproducible manner when a specific enzyme is used. A non-random acetylation pattern includes, for example and without limitation, an alternating or similarly periodic sequence of acetylated and deacetylated units or a block-wise distribution of acetylated and deacetylated units.

The term “polymer” as used in the present invention is used to define molecules having more than 30 monomer units. It differs from the term “oligomer”, which, in the present invention, defines molecules having 30 monomer units or less, typically 25 or less. The term “chitosan oligomers”, as used herein, thus refers to molecules that comprise no more than 30 monomeric units of D-glucosamine and N-acetyl-D-glucosamine. In various embodiments, such oligomers comprise 25 monomeric units or less, 20 units or less, 18 units or less, 16 units or less or 2 to 15 units. The lower limit is the dimer, i.e. a molecule that comprises two monomeric units. Such dimers are considered oligomers in the sense of the present invention. However, in various embodiments, the oligomers of the invention comprise at least 3 units, or 4 or more units. Similarly, the term “chitosan polymer”, as used herein, thus refers to molecules that comprise more than 30 monomeric units of D-glucosamine and N-acetyl-D-glucosamine, typically more than 50, more than 100 or more than 150 units. The number of units can, in various embodiments, be as high as 5000, but is typically 3000 or less, 2000 or less, 1000 or less or in the range of 200-1000, 300-1000 or 500-1000.

The term “monomer” is used in the present invention with the meaning of a constitutional unit of a polymer and interchangeably with “subunit”, “monomer residue”, “residue”, “repeat unit” of a polymer.

The term “structural unit”, as used in the present invention, means a sequence of specific monomers in the polymer.

The term “chitosan polymer”, as used in the present invention, defines a polymer of D-glucosamine units, wherein some but not all D-glucosamine units are acetylated. In other words, the term “chitosan polymer” is used in the present invention without being limited to the fully deacetylated poly-D-glucosamine, but rather covers polymers that contain both monomeric units of D-glucosamine and N-acetyl-D-glucosamine. The degree of acetylation (DA) of the chitosan polymer is typically not more than 30%, for example 30% or less, 28% or less, 25% or less or 22% or less. The lower limit of the degree of acetylation may be 5%, 8% or 10% or 15%. The DA is thus typically 5% or more, 8% or more, 10% or more, or 15% or more. As used herein, the term “chitosan polymer” only covers those molecules that have a DA of less than 50%, preferably only up to 30%. Polymers with higher DA are generally referred to herein as chitins, as defined below.

The term “poly-D-glucosamine”, as used herein, refers to the fully deacetylated chitosan that does not comprise any acetylated D-glucosamine units.

The term “chitin”, as used herein, refers to a polymer comprising N-acetyl-D-glucosamine and D-glucosamine units, with the degree of acetylation being at least 50%, typically at least 60%, at least 70% or at least 80%. The term “poly-N-acetyl-D-glucosamine” is used to designate a polymer that consists of acetylated monomer units, i.e. comprises 100% acetylated units.

The term “GlcN” or “D” as used in the present invention stands for 2-amino-2-deoxy-β-D-glucose or D-glucosamine. If reference is made herein to “glucosamine”, D-glucosamine is meant if not indicated otherwise.

The term “GlcNAc” or “A” as used in the present invention stands for 2-acetamido-2-deoxy-β-D-glucose or N-acetyl-D-glucosamine. If reference is made herein to “N-acetyl-glucosamine”, N-acetyl-D-glucosamine is meant if not indicated otherwise.

The term “degree of acetylation” or “DA”, as used herein, is calculated as ΣA/(ΣA+ΣD)*100 to give the DA in percent (%), wherein in this formula ΣA is the number of GlcNAc units and ΣD the number of GlcN units in a given molecule. The degree of acetylation is, for example, determined by NMR, for example 1H-NMR or 13C-NMR, preferably 1H-NMR. Additionally or alternatively, the degree of acetylation can be determined by means of enzymatic hydrolysis of the chitosan polymer to monomers or small oligomers and quantitative mass spectrometry analysis. Methods to enzymatically hydrolyze a chitosan polymer are known in the art and can be chosen by those skilled in the art based on their general knowledge. In the case of chitosan oligomers, the preferred method for DA determination is mass spectrometry, but other methods such as, but not limited to NMR, Thin Layer Chromatography (TLC), or electrophoresis are also available. Still other methods include titration, dye binding assays, UV spectroscopy, and (FT)IR spectroscopy. Suitable methods are described, for example, in Niehues et al., “Chitosan analysis by enzymatic/mass spectrometric fingerprinting and in silico predictive modeling”, Analytical Chemistry (2017) 89(22):12602-12608, incorporated herein by reference in its entirety.

The term “degree of polymerization” or “DP”, as used herein, refers to the number of monomeric units in a polymer or oligomer molecule. For polymers, it may also be given as the number average degree of polymerization which is given as DPₙ=Mₙ/M₀ with Mₙ being the number average molecular weight of the polymer and M₀ being the molecular weight of a monomeric unit (taking into account the faction of acetylation of the chitosan). The DP of chitosan polymers may be determined by Size Exclusion Chromatography (SEC), preferably SEC with MALLS/RI (multi-angle laser light scattering/refractive index) detection. The DP of chitosan oligomers may be determined by TLC, NMR, or, preferably, mass spectrometry.

The molecular weight of a polymer is, if not indicated otherwise, typically the number average molecular weight (Mₙ). This can be determined by a variety of methods known to those skilled in the art, such as, without limitation, GPC. In various embodiments, the molecular weight may also be determined using the method described in Schatz et al., “Typical physicochemical behaviors of chitosan in aqueous solution”, Biomacromolecules, (2003) 4: 641-648, incorporated herein by reference in its entirety.

The term “deacetylase” as used in the present invention in the term “chitin deacetylase (enzyme)” does not strictly limit the function of the chitin enzyme to a deacetylation reaction. The term “chitin deacetylase” rather refers to the common name of an enzyme that may originate from the fact that it was first discovered as having deacetylating properties. However, a chitin deacetylase (enzyme) may thus also show acetylating properties, depending on various factors, such as substrate concentrations.

The term “about”, as used in the context of the present invention, is intended to mean the referenced numerical value±10%, preferably ±5%.

If amounts are given in % herein, these percentages refer to wt.-% if not indicated otherwise.

The invention is based on the inventors' surprising finding that stable oil-in-water (o/w) emulsions of water-immiscible and/or lipophilic molecules such as plant-derived compounds and mixtures of compounds such as essential oils, but not limited thereto, can be obtained by providing the dispersed phase comprising said water-immiscible and/or lipophilic molecules in the form of droplets that are at least partially coated with chitosan, as described herein below. It has been further found that such o/w emulsions have increased biostimulant, antimicrobial and/or biopesticide activity. It is understood that the water-immiscible and/or lipophilic molecules may be part of an oil phase that may comprise other water-immiscible and/or lipophilic components, such as carriers or carrier oils. In such embodiments, the complete oil phase is provided in form of droplets that are then at least partially coated with chitosans.

It is understood that while the dispersed phase is herein also referred to as “oil phase”, this does not mean that it necessarily comprises an oil in the strict sense of the term, but only may comprise the agricultural active, the emulsifier and optionally a non-oil carrier.

The technology (based on solvent displacement) aims at delivering plant-derived lipophilic molecules such as essential oils, their individual active ingredients, and plant extracts with known or new applications in the agricultural sector as a pesticide (insecticide, nematicide, herbicide, fungicide, or bactericide). These molecules with or without additional carrier oils (such as medium chain triglycerides—vegetable oils) will typically be formulated into an emulsion using an emulsifier, such as lecithin. Each emulsion droplet will then be coated with chitosan polymers or a mixture of polymers and oligomers.

The resulting stable chitosan-coated emulsion could display a size range of 100 nm-1000 nm with a positive zeta potential of +30 mV to +70 mV that may vary based on the lipophilic molecule and chitosan used. In addition to the stabilizing effect introduced by chitosan, these polymers also contribute to the bioactivity of the formulation via their antimicrobial, plant-strengthening, and growth-promoting properties. Finally, under certain formulation conditions, synergistic bioactivity of the encapsulated lipophilic molecule and the chitosan polymer can be observed.

### Compositions

In one aspect, the present invention is thus directed to plant treatment compositions comprising a chitosan-coated emulsion, said chitosan-coated emulsion being an o/w emulsion comprising
(1) a continuous aqueous phase; and
(2) a dispersed phase in form of droplets dispersed in the continuous phase, wherein each droplet is at least partially coated with at least one chitosan and comprises at least one emulsifier, at least one agricultural active and optionally at least one carrier or carrier oil.

In various embodiments the compositions are not cosmetic or pharmaceutical compositions to be used in humans or animals. Such compositions may, in various embodiments, be excluded from the scope of the invention.

### Chitosan

Chitosans are binary copolymers composed of relatively hydrophobic N-acetylglucosamine (GlcNAc), and (at slightly acidic pH values) cationic glucosamine (GlcN) units linked by β-1,4-glycosidic bonds derived from chitin. Chitosans have a broad antimicrobial spectrum to which bacteria and fungi are highly susceptible. In addition, chitosans are known to induce plant-defense responses and enhance photosynthetic activity, vegetative growth, antioxidant activities, fruit quality attributes, and overall growth and yield of the crop.

Chitosans are a family of functional biopolymers, specifically binary copolymers, derived from the partial de-N-acetylation of chitin, one of the most abundant biopolymers in the world, commonly found in insects, fungi, and crustaceans. Whereas chitin, a linear homopolymer of β-1,4-glycosidically linked N-acetyl-D-glucosamine (GlcNAc) residues, forms crystalline fibers and is insoluble in aqueous solvents, chitosans are soluble at slightly acidic pH values, due to the positive charges conveyed by their de-N-acetylated D-glucosamine (GlcN) residues. The structure of chitosans can be described by three parameters: the degree of polymerization (DP) or their molecular weight (Mw), the degree of acetylation (DA), and the pattern of acetylation (PA), the latter referring to the sequence of GlcN and GlcNAc units. These three characteristics strongly influence their physico-chemical solution properties as well as their biological functionalities.

The at least one chitosan used in methods according to the present invention can in principle be any chitosan polymer or oligomer or mixture of polymers and oligomers. Preferred chitosans to be used in accordance with the invention are described in the following.

Suitable chitosan polymers are commercially available, for example as a dietary supplement. While the chitosan used may theoretically be produced by any method including the (partial) deacetylation of chitin or the partial acetylation of poly-D-glucosamine, the commercially most important method is the alkaline deacetylation of chitin, which is available in abundance from natural sources. Such processes commonly involve the use of sodium hydroxide, typically in form of an aqueous solution (40-50 wt.-%), and elevated temperatures and may be further supported by additional treatments, such as ultrasound treatment.

Alternative methods include the enzymatic deacetylation of chitin or high-DA chitosans and the enzymatic acetylation of poly-D-glucosamine or low-DA chitosans.

Partially acetylated chitosans generated via, preferably homogeneous, chemical N-acetylation of GlcN or de-N-acetylation of GlcNAc subunits within the polymers, respectively, typically display random (or near random) patterns of acetylation. “Homogeneous”, as used in this context, means that all reactants are in solution (whereas the typical heterogeneous deacetylation involves the use of soluble NaOH on insoluble chitin).

For enzymatically deacetylating chitin or a chitosan polymer, a chitin deacetylase may be used, for example a bacterial, fungal or viral chitin deacetylase, optionally a recombinant chitin deacetylase, preferably a fungal chitin deacetylase. Exemplary chitin deacetylases include, without limitation, those from Colletotrichum lindemuthianum, Pestalotiopsis sp., Podospora anserina, Mucor rouxii, Puccinia graminis f. sp. tritici, Cryptococcus neoformans or Aspergillus niger. In certain embodiments of the invention, a bacterial chitin deacetylase may be NodB from Rhizobium sp. GRH2 (NCBI acc. No. AJW76244.1), VcCDA from Vibrio cholerae (NCBI acc. No. AAF94439.1), or BcCDA5 from Bacillus sp., a viral chitin deacetylase may be CvCDA from the Chlorovirus CVK2, and a fungal chitin deacetylase may be CnCDA2 (EMBL Nucleotide Sequence Database acc. no. AJ938050) and CnCDA4 (fpd1/d25, Uniprot acc. no. Q96TR5) from Cryptococcus neoformans, Co/LinCDA from Colletotrichum lindemuthianum (Uniprot acc. no. AY633657), AnCDA from Aspergillus niger (Uniprot acc. no. A2QZC8, AspGD ID An12g04480), MrCDA from Mucor rouxii (Uniprot acc. no. P50325), PesCDA from Pestalotiopsis sp. (NCBI acc. no. APH81274.1), PgtCDA from Puccinia graminis f. sp. tritici (NCBI acc. no. XP_003323413.1) or PaCDA from Podospora anserina (NCBI acc. no. CAP60162).

In various embodiments, it is preferred to use a chitosan polymer produced by (preferably homogeneous) alkaline deacetylation of chitin, which produces a random pattern of acetylation in the chitosan polymer. Alternatively, such chitosans with random patterns of acetylation may also be produced enzymatically by choice of starting substrate and enzyme type used.

In various embodiments, chitosan polymers having a non-random pattern of acetylation may be used. Strategies to avoid random acetylation patterns and generate non-random chitosan polymers are described in international patent publication WO 2019/242847 A1.

Independent of whether the polymers have random or non-random acetylation patterns, the degree of acetylation (DA) is typically up to 50, preferably up to 40, more preferably up to 30. The minimum is generally about 2, preferably at least 3, at least 4, at least 5, at least 6, at least 7, at least 8, at least 9 or at least 10. Typical ranges are thus between 5 and 50, for example 5 to 40 or 5 to 30 or 8 to 30 or 10 to 30.

The degree of polymerization (DP) of the polymers, again independent of their pattern of acetylation, is typically up to 5000, preferably up to 4000, up to 3500, up to 3000, up to 2500, up to 2000, up to 1800, up to 1700, up to 1600, up to 1500, up to 1400, up to 1300, up to 1200, up to 1100 orup to 1000. The minimum DP is >30, for example 40 or more, or 50 or more, or 60 or more, or 100 or more or 150 or more. As defined above in relation to the term “polymer”, the number of monomeric units is in principle not limited. Specific ranges are from 100, 150, 200, 250 or 300 to 500, 600, 700, 800, 900 or 1000, with all combinations of lower and upper limits being explicitly covered.

The average molecular weight Mw of the polymers is typically <900.000 g/mol, for example 800.000 or less, 700.000 or less, 600.000 or less, 500.000 or less, 400.000 or less, 300.000 or less, 200.000 or less or 100.000 or less. In various embodiments, the lower limit is about 20.000 g/mol, about 30.000 g/mol, about 40.000 g/mol, about 50.000 g/mol or about 60.000 g/mol. The Mw may for example be in the range of 20.000 to 200.000 g/mol, 30.000 to 150.000, 40.000 to 100.000 g/mol, 50.000 to 80.000 g/mol, or 55.000 to 65.000 g/mol. The polydispersity of the polymers is typically 2 or less, for example 1.5 or less.

Chitosan oligomers that may be used in the context of the present invention can be generated by hydrolysis of chitosan polymers, such as the chitosan polymers described herein above. Hydrolysis may be chemical and/or enzymatical.

In various embodiments, the average molecular weight Mw of the educt chitosan polymers used for hydrolysis may be in the range of from about 6.000 g/mol to about 1.000.000 g/mol, preferably from about 10.000 g/mol to 250.000 g/mol, or any of those given above.

The educt chitosan polymer used for hydrolysis is not fully deacetylated but comprises a certain number of N-acetyl-D-glucosamine units. In various embodiments, the chitosan polymers used for hydrolysis have a degree of acetylation (DA) in % of at least 1, at least 2, at least 3, at least 4, at least 5, at least 7, at least 10 or at least 15 and up to 30 or up to 25. The DA may be as given for the polymers useful in the inventive emulsions above. Such polymers are commonly obtained from the known methods of chitin deacetylation, as the reaction is typically incomplete.

The degree of polymerization (DP) of the educt chitosan polymers used for hydrolysis may be as defined above for the polymers useful in the compositions of the invention. The DP of the oligomers is no more than 30 monomeric units of D-glucosamine and N-acetyl-D-glucosamine. In various embodiments, the oligomers comprise 25 monomeric units or less, 20 units or less, 18 units or less, 16 units or less or 2 to 15 units or have the corresponding DP.

In various embodiments, chitosan polymers useful in accordance with the present invention are selected from chitosan polymers obtained by enzymatic hydrolysis, for instance by enzymatic hydrolysis of chitosan polymers as described herein.

For enzymatic hydrolysis, the chitosan hydrolases used may be selected from any known chitosan hydrolase, typically from chitosanases and chitinases, but also chitinosanases, or other enzymes such as proteases or lipases known to be able to depolymerize chitosan. The selection of the enzyme depends on the desired type of oligomer to be obtained. The chitosanases and chitinases and chitinosanases or other enzymes may be selected from eukaryotic, for example mammalian, bacterial, viral and fungal enzymes. The enzymes may differ in their specificity and cleavage site.

Exemplary chitosanases suitable in this context include, without limitation, Csn-MN from Bacillus spec MN, Csn-MHKI from Bacillus circulans MH-K1, Csn-7M from Bacillus spec. No. 7-M, Csn-MN-VRE from Bacillus spec. MN, and CSN174 from Streptomyces N174. These are examples for three different types of chitosanases that differ in substrate specificity and cleavage site. In various embodiments, the chitosanase is Csn-MN from Bacillus spec MN. Further disclosure on these enzymes are found in Nampally et al. (Nampally et al. (2012). Appl. Environ. Microbiol. 78 (9): 3114-3119. https://doi:10.1128/AEM.07506-11), Weikert et al. (Weikert et al. (2017), Nat Commun 8, 1698. https://doi.org/10.1038/s41467-017-01667-1), Regel et al. (Regel et al. (2018). Biotechnology and Bioengineering. 115: 863-873. https://doi.org/10.1002/bit.26533), Singh et al. (Singh et al. (2019) Sci Rep 9, 1132. https://doi.org/10.1038/s41598-018-36213-6).

Exemplary chitinases suitable in this context include, without limitation, ChiB from Serratia marcescens, TvChi from Trichoderma virens, ChiG and ChiF from Streptomyces coelicolor A3(2), and Lysozyme and Chitotriosidase from Homo sapiens. These are examples for three different types of chitinases that differ in substrate specificity and cleavage site. Said enzymes have also been described in Matano et al. (Mateno et al. (2016). BMC Microbiol 16, 177 https://doi.org/10.1186/s12866-016-0795-3), Bußwinkel et al. (Bußwinkel et al. (2018), International Journal of Biological Macromolecules, 114, 453-461, https://doi.org/10.1016/j.ijbiomac.2018.03.070), Hoell et al. (Hoell et al. (2006). FEBS J 273 (21): 4889-4900. https//doi: 10.1111/j.1742-4658.2006.05487.x.), Kawase et al. (Kawase et al. (2006). Biosci Biotechnol Biochem 70 (4): 988-998. https://doi.org/10.1271/bbb.70.988), Stokke et al. (Stokke et al. (1995). Can. J. Chem. 73, 1972-1981. https://doi.org/10.1139/v95-244), Eide et al. (Eide et al. (2012), Biochemistry 51, 487-495 (2012). https//doi.org/10.1021/bi2015585).

Exemplary chitinosanases suitable in this context include, without limitation, AaChio isolated from Alternaria alternata. Said enzyme has also been described in Kohlhoff et al. (Kohlhoff et al., Carbohydrate Polymers 174 (2017): 1121-1128. https://doi.org/10.1016/j.carbpol.2017.07.001). Suitable enzymes are also described in European patent publication EP 2 090 651 A1.

In various embodiments, chitosan oligomers having a non-random pattern of acetylation may be used. Strategies to avoid random acetylation patterns and generate non-random chitosan oligomers are described in international patent publication WO 2023/001913 A1, incorporated herein by reference in its entirety.

Chitosan oligomers useful for application in the context of the present invention may be random or non-random, as already defined in the context of chitosan polymers herein above.

In various embodiments, a mixture of chitosan polymers and chitosan oligomers may be used. While such a mixture may be obtained by (partial) hydrolysis, either chemically or enzymatically, of chitosan polymers, a mixture of chitosan polymer and oligomers suitable for application in the context of the present invention may also be obtained by combining chitosan polymers with chitosan oligomers, which may comprise the mixing of chitosan polymers and chitosan oligomers (optionally obtained from different sources or by different methods).

In various embodiments, the at least one chitosan is selected from random and non-random chitosan polymers, random and non-random oligomers, and any mixtures of the aforementioned, for instance non-random chitosan polymers and random chitosan oligomers. In various embodiments, it may be advantageous if the chitosan used in accordance with the present invention is selected from random chitosan polymers or a mixture of random chitosan polymers and oligomers. If a mixture of polymers and oligomers is used, the weight ratio of polymers to oligomers may range from 50:1 to 1:10, for example 20:1 to 1:5, or 15:1 to 1:1, or 10:1 to 5:1.

In various embodiments, the at least one chitosan, as herein described and defined above, may have an average molecular weight Mw of <900.000 g/mol, such as in the range of 300 to 890.000 g/mol, for instance in the range of 1000 to 300.000 g/mol.

Alternatively or additionally, the degree of acetylation (DA) of chitosans suitable for employment in the context of the present invention may be up to 30, preferably in the range of 10 to 30, such as, for instance and without limitation, 20 to 30.

Alternatively or additionally, the degree of polymerization (DP) may be up to 5000, preferably up to 4000, more preferably up to 3000, such as up to 2000, most preferably up to 1200.

In various embodiments, the chitosan is selected from the group consisting of random chitosan polymers and oligomers, wherein the chitosan polymers and oligomers independently of each other have a DA of up to 30, preferably 10 to 30, and wherein the chitosan polymers have a Mw of 40.000 to 100.000 g/mol, preferably 50.000 to 80.000 g/mol, more preferably 55.000 to 65.000 g/mol.

In various other embodiments, the chitosan is selected from the group consisting of mixtures of random chitosan polymers and oligomers, wherein the chitosan polymers and oligomers independently of each other have a DA of up to 30, preferably 10 to 30, and wherein the chitosan polymers have a Mw of 40.000 to 100.000 g/mol, preferably 50.000 to 80.000 g/mol, more preferably 55.000 to 65.000 g/mol.

In various such embodiments, said mixture of random chitosan polymers and oligomers comprises at least 10 wt.-%, such as at least 20 wt.-%, for instance at least 30 wt.-%, based on the total weight of chitosan polymers and oligomers, of chitosan oligomers having a random PA and a DP of <30, such as, for instance and without limitation 30, 25, 20, 15, 10, 5, 4, 3, or 2.

### Agricultural Active

In the context of the present invention, the at least one agricultural active is a compound or mixture of compounds that is miscible and/or soluble in the dispersed phase and immiscible and/or insoluble in the continuous phase. In other words, in the context of the present invention, the agricultural active is water-immiscible and/or water-insoluble, which preferably means, in the context of the present invention, that less than 30 wt.-%, preferably 20 wt.-%, more preferably less than 15 wt.-%, even more preferably less than 10 wt.-%, in particular less than 5 wt.-%, for instance, less than 1 wt.-%, based on the total weight of the agricultural active, is present in the aqueous phase of the chitosan-coated emulsion according to the present invention at room temperature (20 °C). In various embodiments, the weight ratio between the amount of agricultural active present in the discontinuous phase and the amount of agricultural active present in the continuous phase is 60:40, preferably 70:30, more preferably 75:25, even more preferably 80:20, particularly 85:15, more particularly 90:10, 95:5 or 99:1.

In various embodiments, the solubility of the agricultural active in water (at 20 °C and pH 7) is less than 10 g/L water, preferably less than 5 g/L, more preferably less than 1 g/L.

The agricultural active typically has pesticidal and/or plant stimulating activity. “Pesticidal activity”, as used in this context, means that it can inhibit or block the growth of any type of organism that is considered a pest in the agricultural field. This includes the various plants pathogens, such as bacteria, fungi, and various invertebrates, such as insects, mites and nematodes, but may also cover various weeds. Said activity also implies that the growth and health of the crop to be protected is essentially unaffected by said pesticidal activity or can be provided or ensured by the additional use of safeners.

The inhibition or block of the growth may involve killing the respective harmful organism, but generally refers to a decrease in its growth and viability relative to the same organism not contacted or treated with said active. Similarly, “plant stimulating activity” includes various effects on plants, including increase in growth, fruit/seed production, vitality, stress tolerance, pathogen resistance, and the like.

In various embodiments, the agricultural active is selected from the group consisting of naturally derived compounds, synthetic compounds and mixtures thereof. Examples of naturally derived compounds and mixtures of naturally derived compounds include essential oils, plant extracts, plant-derived compounds and mixtures thereof. Further examples include chemically synthesized or non-natural actives. The latter may be produced by chemical synthesis or also by biotechnological means. “Non-natural actives” relates to compounds that are generally are non-natural in that they do not occur in nature but are artificially designed and/or produced.

The at least one agricultural active is different from the at least one chitosan, the emulsifier and the carrier (oil) as well as the water-miscible organic solvent, described herein. While it may have emulsifying or carrier properties, it is still distinct from the compounds herein termed as such and is rather predominantly used for its agricultural activity, for example as a pesticide or biostimulant.

In various embodiments, the at least one agricultural active is selected from naturally derived or synthetic fungicides, herbicides, pesticides, antimicrobial agents, and any mixtures thereof. In various embodiments, the at least one agricultural active is a (naturally derived or synthetic) pesticide, such as a fungicide, insecticide, herbicide, bactericide, or nematicide, and/or a plant growth regulator. In various embodiments, it may for example be a fungicide.

Particular, however non-limiting, examples of synthetic (types of) compounds or mixtures of synthetic compounds include known fungicides. Examples include, without limitation, aminopyridines such as fluazinam, anilinopyrimidines such as cyprodinil, benzamides such as fluopyram, conazoles such as epoxiconazole and hexaconazole, dioxazines such as fluoxastrobin, imidazoles such as imazalil, morpholines such as dimethomorph and fenpropidine, phenylpyrroles such as fludioxonil, phthalonitriles such as chlorothalonil, pyrazoles such as benzovindiflupyr, bixafen, fluxapyroxad and penthiopyrad, pyridinecarboxamides such as boscalid, pyrimidines such as bupirimate, strobilurins such as azoxystrobin, trifloxystrobin and pyraclostrobin, triazoles such as tebuconazole and metconazole.

In another embodiment, the insecticide is selected from the group consisting of benzoyl ureas such as novaluron, lufenuron, chlorfluazuron, flufenoxuron, hexaflumuron, noviflumuron, teflubenzuron, triflumuron and diflubenzuron; carbamates; pyrethroids such as cyhalothrin and isomers and isomer mixtures thereof, lambda-cyhalothrin, deltamethrin, tau-fluvalinate, cyfluthrin, beta-cyfluthrin, tefluthrin, and, bifenthrin; organophosphates such as azinfos-methyl, chlorpyrifos, diazinon, endosulfan, methidathion; neonicotinoids, and phenylpyrazoles such as imidacloprid, acetamiprid, thiacloprid, dinotefuran, thiamethoxam and fipronil.

Non-limiting examples of nematicides include fluopyram, fluensulfone, 1,3-dichloropropene, abamectin, emamectin benzoate, fenamiphos and azadirachtin.

In another embodiment, the herbicide is selected from the group consisting of aryloxyphenoxy derivatives, aryl ureas, aryl carboxylic acids, aryloxy alkanoic acid derivatives such as clodinafop-propargyl and analogues thereof, fenoxaprop-p-ethyl and analogues thereof, propaquizafop, quizalafop and analogues thereof, dinitroanilines such as pendimethalin and trifluralin; diphenyl ethers such as oxyfluorfen, imidazolinones, sulfonylureas such as chlorsulfuron, nicosulfuron, rimsulfuron, tribenuron-methyl, sulfonamides, triazines, and triazinones such as metamitron.

Non-limiting examples of naturally derived agricultural actives in the context of the present invention include essential oils, other plant extracts as well as individual compounds of plant extracts and/or essential oils, as well as any mixtures of the aforementioned.

The term “essential oil” as used in the context of the present invention is intended to mean water-immiscible and/or hydrophobic oils derived from plant matter, that contain less than 40 wt.-%, preferably less than 30 wt.-%, more preferably less than 20 wt.-%, in particular preferred less than 10 wt.-%, especially preferred less than 5 wt.-%, particularly preferred less than 1 wt.-% and most preferred 0 wt.-% of lipids or lipid oils. Lipids are understood as being compounds based on fatty acids and derivatives of fatty acids. Lipid oils are understood as being oils based on fatty acids and derivates of fatty acids (such as glyceride oils), whereas many essential oils have a base of terpene hydrocarbons. While non-limiting examples of essential oils include Citrus oils, mint oils, cedarwood oil, Eucalyptus oil, clove oil, etc., non-limiting examples of vegetable lipid oils include sunflower oil, olive oil, peanut oil, soya oil, corn oil, etc. In the context of the present invention, the term “essential oil” shall also be taken to encompass mixtures of more than one essential oil.

In more detail an essential oil is a water-immiscible and/or hydrophobic liquid (at room temperature, 20 °C, and atmospheric pressure) containing volatile aroma compounds extracted from plants. Essential oils are composed primarily of terpenes and of lesser quantities of, e.g., alcohols, aldehydes, esters, and/or phenols. They are usually obtained from plants, leaves, flowers, roots, buds, twigs, rhizomes, heartwood, bark, resin, seeds and/or fruits. Essential oils are usually found in special secretory glands or cells within the plants. Each essential oil contains its own blueprint of chemical entities that is absolutely unique to that specific oil. Different techniques are known to obtain essential oils from plants. Essential oils useful for employment in the context of the present invention may be produced by distillation or solvent extraction with hydrophobic solvents or supercritical solvents.

In various embodiments, non-limiting examples of essential oils suitable for employment in the context of the present invention include essentials oils selected from the group consisting of allspice oil, ambrette seed oil, amyris oil, Angelica root oil, anise oil, anthopogon oil, arborvitae oil, basil oil, bay laurel oil, beeswax absolute, bergamot oil, bergamot mint oil, bitter orange oil, black pepper oil, black spruce oil, blood orange oil, blue cypress oil, blue spruce oil, blue tansy oil, bois de rose oil, Boronia absolute, Bursera graveolens oil, cade oil, cajeput oil, camphor oil, Cananga oil, Cannabis oil, cardamom oil, carrot seed oil, Cassia oil, castor oil, catnip oil, cedar oil, chamomile oil, cilantro oil, cinnamon oil, Cistus oil, Citrus oil, citronella oil, clary sage oil, clove oil, coffee oil, common sage oil, copaiba balsam oil, coriander oil, corn oil, cornmint oil, cottonseed oil, cubeb oil, cumin oil, cypress oil, davana oil, dill oil, elemi oil, Eucalyptus oil, fennel oil, fir oil, fragonia oil, frankincense oil, Galbanum oil, garlic oil, geranium oil, ginger oil, goldenrod oil, grapefruit oil, greenland moss oil, gurjum balsam oil, helichrysum oil, hemp oil, hinoki oil, ho oil, hops oil, hyssop oil, ishpingo oil, lavender oil, jasmin oil, juniper oil, Kunzea oil, laurel oil, lavandin oil, lavender oil, ledum oil, lemon oil, lemon balm oil, lemon Eucalyptus oil, lemongrass oil, lemon myrtle oil, lemon tea tree oil, lemon Verbena oil, lime oil, linden oil, linseed oil, mandarin oil, manuka oil, marjoram oil, may chang oil, melissa oil, mint oil, myrrh oil, myrtle oil, neem oil, neroli oil, niaouli oil, nutmeg oil, oakmoss oil, onion oil, opoponax oil, orange oil, oregano oil, palmarosa oil, palo santo oil, parsley oil, patchouli oil, peppermint oil, pink pepper oil, peru balsam oil, petitgrain oil, pimento oil, pine oil, plai oil, pomelo oil, Rhododendron oil, Rosalina oil, rose oil, rosemary oil, rosewood oil, sage oil, sandalwood oil, saro oil, Sassafras oil, spearmint oil, spikenard oil, spruce oil, star anis oil, Styrax benzoin absolute, sweet orange oil, Tagetes oil, tangerine oil, tea tree oil, thyme oil, tobacco oil, tuberose oil, tulsi oil, valerian oil, vanilla oil, vetiver oil, violet oil, white tea tree oil, wintergreen oil, xanthoxylum oil, yarrow oil, ylang ylang oil, yuzu oil, and mixtures thereof. Also encompassed are individual components thereof.

In various embodiments, non-limiting examples of individual components or compounds of plant extracts and/or essential oils suitable for employment in the context of the present invention include compounds selected from the group consisting of (+/−)-bornyl acetate, (+/−)-carveol, (+/−)-caryophyllene oxide, (+/−)-citronellal, (+/−)-dihydrocarvyl acetate, (+/−)-fenchone, (+/−)-isopinocampheol, (+/−)-isopulegol, (+/−)-menthone, (+/−)-menthyl acetate, (+/−)-myrtenol, (+/−)-perillylalcohol, (+/−)-trans-myrtanol, (+/−)-verbenone, (+)-2-carene, (+/−)-cuparene, (+/−)-dihydrocarveol, (+/−)-dihydrocarvone, (+/−)-isomenthol, (+/−)-borneol, (+/−)-alpha-pinene, (+/−)-beta-pinene, (+/−)-beta-citronellol, (+/−)-camphor, (+/−)-linalool, (+/−)-menthol, (+/−)-neomenthol, (1R)-chrysanthemolactone, (1 S,2S)-10-pinanol, (cis/trans)-nerolidol, 1,4-cineole, 1,8-cineole, 2-isopropyl-5-methylphenol (thymol), 2-norbornanone, 3-carene, 3-octanone, 4-menthan-3-one, acetic acid butylester, 2-phenylethyl propionate, acetic acid cinnamylester, acetic acid heptylester, acetic acid isobutylester, acetic acid methylester, alpha-(−)-bisabolol, alpha-caryophyllene, alpha-cedrene, alpha-humulene, alpha-ionone, alpha-terpinene, alpha-terpineol, azulene, benzoic acid eugenylester, beta-cedrene, beta-naphthol, beta-thujaplicin, butyl acetate, cajeputol, camphene, cedar camphor, cedrol, chamazulen, cinnamyl acetate, cis-jasmone, cis-nerolidol, citral, citronellol, cuminaldehyde, cypress camphor, dihydrocarveol, dillapiole, DL-citronellyl acetate, estragole, eucalyptol, eugenol methylether, eugenylbenzoate, exo-2-camphanol, farnesol, furfuryl acetate, furfuryl alcohol, gamma-terpinene, geranyl acetate, geraniol, heptyl acetate, isobornyl acetate, isobornyl isovalerate, isobutyl acetate, isocineole, isoeugenol, isoeugenylacetate, isolongifolene, isomenthone, isothymol, lemonol, linalool oxide, linalyl acetate, nerol, nootkatone, p-allylanisole, piperitone, R-(−)-alpha-phellandrene, R-(+)-limonene, R-(+)-pulegone, S-(−)-limonene, sabinene, sabinyl acetate, terpinolene, terpinyl acetate, tetrahydrolinalool, trans-nerolidol, trans-stilbene, eugenol, and lavendulol as well as any mixtures of two or more of the afore-mentioned.

### Emulsifier

Emulsifiers are surface active substances which promote the suspension of one liquid in another and promote the formation of a stable mixture, or emulsion, of oil and water, and are generally known in the art.

Substantially any emulsifier can be used in accordance with the methods described herein.

Common examples of suitable emulsifiers include monoglycerides, sorbitan esters, alkylene glycol esters such as propylene glycol esters, phospholipids such as lecithins, polysorbates, cremophor, sucrose esters of medium chain saturated fatty acids (e.g., having an acyl group containing 10 or more carbon atoms, typically 10 to 24 carbon atoms, for example 12 to 18 carbon atoms), sucrose esters of long chain saturated fatty acids, (e.g., saturated fatty acids which contain from about 12 to about 18 carbons), and sucrose esters of unsaturated fatty acids (e.g., unsaturated fatty acids which contain from about 12 to about 22 carbons, such as oleic acid, linoleic acid, eicosapentaenoic acid, arachidonic acid, and docosahexaenoic acid).

More specific examples of suitable emulsifiers include, for instance and without limitation, gum acacia, anionic emulsifying wax, algin, carrageenan, calcium stearate, carbomers, cetostearyl alcohol, cetyl alcohol, cholesterol, diethanolamine, ethylene glycol palmitostearate, glycerin monostearate, glyceryl monooleate, hydroxypropyl cellulose, hypromellose, lanolin, lanolin alcohols, lecithin, medium-chain triglycerides, methylcellulose, mineral oil and lanolin alcohols, monobasic sodium phosphate, monoethanolamine, nonionic emulsifying wax, oleic acid, poloxamers, polyoxyethylene alkyl ethers, polyoxyethylene castor oil derivatives, polyoxyethylene sorbitan fatty acid esters, polyoxyethylene stearates, propylene glycol alginate, (self-emulsifying) glyceryl monostearate, sodium citrate dehydrate, sodium lauryl sulfate, sodium dioctyl sulfosuccinate, sorbitan esters, span, stearic acid, tragacanthins, triethanolamine, tween, xanthan gum and combinations thereof.

### Carrier (Oil)

An optional ingredient of the emulsions is a carrier or carrier oil. Thus, according to various embodiments, the organic phase can comprise a carrier (oil).

For example, a carrier oil can be a synthetic or natural oil derived from plant, animal or mineral sources, preferably derived from plant sources such as derived from seeds, nuts, fruits, flowers, leaves, or other parts of plants, or any combinations thereof. Examples of carriers include, but are not limited to, sweet almond oil, olive oil, wheat germ oil, castor oil, avocado oil, carrot oil, pumpkin oil, rosehip seed oil, calendula oil, jojoba oil, grape seed oil, apricot kernel oil, flaxseed oil, hazelnut oil, walnut oil, pecan nut oil, macadamia nut oil, sesame oil, emu oil, coconut oil, safflower oil, sunflower oil, canola oil, soybean oil, palm oil, palm kernel oil, peanut oil, poppy seed oil, rapeseed oil, linseed oil, and any combinations thereof. The carrier or carrier oil can include free fatty acids, mono-, di- and triglycerides, fatty acid ethyl esters, or a combination thereof.

### Emulsions

The emulsion may comprise the at least one chitosan in an amount of from 0.001 to 50% (w/w), preferably in an amount of 0.005 to 10% (w/w), more preferably in an amount of 0.01 to 1% (w/w) relative to the total weight of the emulsion.

The at least one emulsifier may be comprised in the emulsion in an amount of from 0.001 to 50% (w/w), preferably in an amount of 0.005 to 10% (w/w), more preferably in an amount of 0.01 to 5% (w/w) relative to the total weight of the emulsion.

In various embodiments, the plant treatment composition wherein the chitosan-coated emulsion comprises at least one carrier (oil) in an amount of from 0.0001 to 95% (w/w), preferably in an amount of 0.001 to 70% (w/w), more preferably in an amount of 0.01 to 50% (w/w) relative to the total weight of the emulsion.

The at least one agricultural active may be comprised of an amount of from 0.0001 to 90% (w/w), preferably in an amount of 0.001 to 70% (w/w) most preferably in an amount of 0.01 to 50% (w/w), relative to the total weight of the emulsion.

The compositions may, in addition to the at least one chitosan-coated emulsion, comprise at least one further component, such as, without limitation, one or more auxiliaries or excipients. Also possible are diluents or solvents. The type and amount of such additional components may depend on the planned application or use and can be adapted accordingly. Formulation techniques and methods for different types of compositions envisaged herein, for instance agricultural compositions, are well known to those skilled in the art and routinely practiced.

Further components or ingredients to be combined with the herein described emulsions so as to obtain a composition comprising at least one chitosan-coated emulsion according to the present invention include, for example and without limitation, one or more ingredients selected from additional solvents, such as water or organic solvents, additional fungicides, antibiotics and/or nematicides, amino acids such as glycine or alanine; antioxidants such as phytic acid; colorants such as dyes or pigments; consistency regulators such as thickeners, e.g., naturally derived or synthetic polymer-based thickeners such as cellulose-based or gum arabic; minerals; pH regulators; preservatives such as salicylic acid; stabilizing agents such inorganic and organic UV photoprotective filters; polysaccharides such as alginate and ulvan; surfactants, e.g., non-ionic, anionic, cationic or amphoteric surfactants; and vitamins such as vitamin C.

In various embodiments, the emulsions described herein comprise water, for example in an amount of at least 20% (w/w), at least 25% (w/w), at least 30% (w/w), at least 35% (w/w), at least 40% (w/w), at least 45% (w/w), at least 50% (w/w), at least 55% (w/w), at least 60% (w/w), at least 65% (w/w), at least 70% (w/w), at least 75% (w/w), at least 80% (w/w), at least 85% (w/w), or at least 90% (w/w). The amount of water in the emulsion may depend on whether it is a concentrate or a ready-to-use emulsion. In the former case, the amount of water may be low, for example 50% (w/w) or less, 40% (w/w) or less, 35% (w/w) or less, 30% (w/w) or less, or 25% (w/w) or less, and it may be diluted with additional water prior to use. In the latter case, the amount of water may be high, for example at least 50% (w/w), at least 55% (w/w), at least 60% (w/w), at least 65% (w/w), at least 70% (w/w), at least 75% (w/w), at least 80% (w/w), at least 85% (w/w), or at least 90% (w/w).

In various embodiments, a composition according to the present invention comprises at least one chitosan-coated emulsion (chitosan-stabilized emulsion) in an amount of from 0.01 to 99.99 wt.-%, such as in an amount of from 0.1 to 99.1 wt.-%, for instance in an amount of from 1 to 99 wt.-%, 2 to 98 wt.-%, 5 to 95 wt.-%, 10 to 90 wt.-%, 15 to 85 wt.-%, 20 to 80 wt.-%, 30 to 70 wt.-%, 40 to 60 wt.-%, or 50 wt.-%, based on the total weight of the composition.

### Methods of Preparation

In another aspect, the present invention relates to a method for the preparation of a chitosan-coated o/w (oil-in-water) emulsion, said chitosan-coated emulsion comprising an aqueous continuous phase and a non-aqueous dispersed phase, wherein the dispersed phase is in the form of droplets dispersed in the continuous phase, said droplets being at least partially coated with at least one chitosan, the method comprising the steps of:
a) providing an aqueous phase comprising said at least one chitosan,
b) providing an organic phase comprising at least one water-miscible organic solvent, at least one emulsifier, at least one agricultural active and optionally at least one carrier (oil),
c) emulsifying the organic phase in the aqueous phase, and
d) optionally, reducing the volume of the emulsion obtained in step c) to about 25% to 80% of its original volume, optionally by means of evaporation.

In step a) of the method of the present invention, an aqueous phase is provided, wherein said aqueous phase comprises at least one chitosan. The water used as a base for the aqueous phase may be, for instance, tap water or purified water, such as distilled water.

Typically, the providing of the aqueous phase encompasses the mixing of the at least one chitosan into water. In various embodiments, one or more acids may be added to the water so as to improve solubilization of the at least one chitosan in the aqueous phase. Preferably, acids suitable for employment in the context of the present invention are selected from organic and inorganic acids and mixtures thereof. Non-limiting examples of organic acids suitable for employment in the context of the present invention include acetic acid, lactic acid, citric acid, malic acid, tartaric acid, formic acid, oxalic acid, pyruvic acid, and mixtures thereof. Non-limiting examples of inorganic acids suitable for employment in the context of the present invention include hydrochloric acid and nitric acid, as well as mixtures thereof. In various embodiments, it may be useful to set the pH of the aqueous phase to be in the range of about 4.0 to 7.0, preferably 4.5 to 6.5, more preferably 5.0 to 6.0 so as to improve solubilization of the at least one chitosan in the aqueous phase. Alternatively or additionally, the aqueous phase may be stirred for a duration of 0.5 to 24 hours, more preferably 1 to 20 hours, such as 3 to 15 hours, for instance 3, 4, 5, 6, 7, 8, 9, 10, 11 or 12 hours so as to improve solubilization of the at least one chitosan in the aqueous phase.

Typically, the at least one chitosan, as defined and described herein above, is present in an amount of from 0.01 to 5% (w/v), preferably in an amount of 0.02 to 1% (w/v), more preferably in an amount of 0.05 to 0.5% (w/v) in the aqueous phase in step a).

In step b) of the method of the present invention, an organic phase is provided, comprising at least one water-miscible organic solvent, at least one emulsifier, at least one agricultural active and optionally at least one carrier (oil). The providing of said organic phase typically is achieved by mixing the respective components into the at least one water-miscible organic solvent. The order of addition of the individual components is not of particular importance. For instance, but without limitation, the carrier (oil), insofar used, may be provided in a first step to which, in a next addition step, the agricultural active may be added, followed by addition of the emulsifier, to which mixture then the organic solvent may be added. Any of the respective ingredients may be pre-solubilized in the organic solvent before addition of the respective ingredient, for instance the emulsifier and/or the agricultural active.

The water miscible organic solvent to be used in accordance with the present invention in method step b) is a solvent that interdissolves with water and is a liquid material at room temperature. Examples include, without limitation, alcohols, including, but not limited to, polyhydric alcohols such as dihydric alcohols (e.g., glycols, e.g., propylene glycol, ethylene glycol, tetraethylene glycol, triethylene glycol, trimethylene glycol), which contain two hydroxyl groups or trihydric alcohols (e.g., glycerin, butane-1,2,3-triol, pentane-1,3,5-triol, 2-amino-2-hydroxymethyl-propane-1,3-diol), which contain three hydroxyl groups, and monohydric alcohols (e.g., methanol, ethanol, propanol, isopropanol, n-butanol and t-butanol); ketones, such as acetone, butyl acetate, or ethyl acetate; aldehydes such as acetaldehyde; ethers, such as dioxane or tetrahydrofuran; amines such as ethanolamine; amides, such as dimethylformamide; polyethylene glycols; sulfoxides, such as dimethyl sulfoxide; and their derivatives. It may be preferred that said water-miscible solvent is removable either as such or as an azeotropic mixture with water in optional step d).

Typical amounts of water-miscible organic solvent to be employed in accordance with method step b) of the present invention are from 99 to 30% (v/v), preferably 96 to 50% (v/v), more preferably 93 to 80% (v/v) of the organic phase of step b).

Typically, the at least one emulsifier to be incorporated in the organic phase in accordance with step b) of the herein described method is present in an amount of from 1 to 12% (w/v), preferably in an amount of 3 to 10% (w/v), more preferably in an amount of 4 to 8% (w/v) in the organic phase in step b).

In various embodiments, wherein at least one carrier (oil) is present in the organic phase provided in step b) of the herein described method, typical amounts of carrier (oil) to be included are comprised within the range of from 0.01 to 5% (v/v), preferably 0.2 to 2% (v/v), more preferably 0.5 to 1.5% (v/v) in the organic phase in step b).

Typically, the at least one agricultural active is present in an amount of from 1 to 15% (v/v), preferably in an amount of 2 to 12% (v/v), more preferably in an amount of 3 to 10% (v/v), preferably >3 to 8% (v/v), in the organic phase of step b).

In step c) of the method according to the present invention, the organic phase obtained in step b) is emulsified in the aqueous phase obtained in step a) so as to obtain a chitosan-coated emulsion (chitosan-stabilized emulsion) according to the present invention. Methods of emulsification so as to obtain an o/w emulsion are generally known to the skilled person. For instance, emulsification may be effected at room temperature by directly pouring the organic phase obtained in step b) and subsequent emulsifying of the thusly obtained mixture. Emulsification may, in various embodiments, require nothing more than (gentle) agitation of the obtained mixture, such as by tilting and/or shaking of the respective receptacle and/or by stirring of the mixture using stirring utensils such as a rod. Alternatively or additionally, commonly known mixing appliances may be employed, such as (vacuum) emulsifying mixers, stirred vessel/agitators, static mixers and homogenizers, such as high pressure homogenizers, and rotor-stator mixers.

Typically, the average particle/droplet size (diameter) of the dispersed phase is preferably less than or equal to 4 μm, preferably from 20 to 2000 nm, more preferably from 50 to 1000 nm, particularly from 100 to 800 nm. Methods for the determination of the average particle size are generally known to a skilled person, such as dynamic light scattering, for instance using a ZetaSizer.

In various embodiments, the emulsion according to the present invention has a positive zeta potential, preferably of from +30 mV to +70 mV. Methods for determining the zeta potential of a given emulsion are generally known to a person skilled in the art and may, for instance, be done using Zeta Potential Analyzers. Measurement of the zeta potential can also generally be performed using microelectrophoresis, or electrophoretic light scattering, or electroacoustic phenomena. The emulsion disclosed and described herein is stable, which means that it retains its positive zeta potential greater than +30 mV overtime, such as during storage.

In various embodiments, the method may include a step d) of reducing the volume of the emulsion obtained in step c) to about 25% to 80% of its original volume, for instance to a volume of 25, 30, 35, 40, 45, 50, 55, 60, 65, 70, 75 or 80% of its original volume, for instance to a volume of 25 to 55% of its original volume or to a volume of 55 to 80% of its original volume. Means of effecting said reduction of volume in accordance with the method of the present invention may, for instance but without limitation, encompass evaporation, resulting in at least partial removal of the at least one organic water-miscible solvent present in the emulsion obtained in step c), as described herein above. Evaporation may, in various embodiments, comprise the application of heat and/or induction of vacuum conditions, optionally while subjecting the emulsion to agitation. Reduction of the volume of the emulsion in accordance with optional method step d) results in reduction of the content of organic solvent in the emulsion, i.e., a concentrated chitosan-coated emulsion, and may thus be advantageous in various fields of application of the emulsions of the present invention, such as in agricultural settings and applications.

In various embodiments, the method of preparation according to the present invention comprises at least one method step d), such that the volume of the emulsion obtained in step c) is reduced to about 25% to 55% of its original volume.

In various other embodiments, the method of preparation according to the present invention comprises at least one method step d), such that the volume of the emulsion obtained in step c) is reduced to about 55% to 80% of its original volume, such as 55 to 70% of its originally volume.

According to some embodiments, in step d), the volume of the emulsion obtained in step c) is reduced to about 25% to 55% of its original volume and the chitosan is present in an amount of from 0.02 to 0.5% (w/v), preferably in an amount of 0.05 to 0.2% (w/v) in the aqueous phase in step a); and/or the emulsifier is present in an amount of from 2 to 10% (w/v), preferably in an amount of 4 to 8% (w/v) in the organic phase in step b).

In some such embodiments, in step d), the volume of the emulsion obtained in step c) is reduced to about 25% to 55% of its original volume and the chitosan is present in an amount of from 0.02 to 0.5% (w/v), preferably in an amount of 0.05 to 0.2% (w/v) in the aqueous phase in step a) and the emulsifier is present in an amount of from 2 to 10% (w/v), preferably in an amount of 4 to 8% (w/v) in the organic phase in step b). In some such embodiments, it is preferable that the at least one agricultural active be present in an amount of from 3 to 10% (v/v) in the organic phase of step b), preferably >3 to 8% (v/v).

According to various other embodiments, in step d), the volume of the emulsion obtained in step c) is reduced to about 55% to 80% of its original volume, such as 55 to 70% of its originally volume, and the chitosan is present in an amount of from 0.05 to 0.8% (w/v), preferably in an amount of 0.1 to 0.4% (w/v) in the aqueous phase in step a); and/or the emulsifier is present in an amount of from 2 to 10% (w/v), preferably in an amount of 4 to 8% (w/v) in the organic phase in step b).

In some such embodiments, in step d), the volume of the emulsion obtained in step c) is reduced to about 55% to 80% of its original volume, such as 55 to 70% of its originally volume, and the chitosan is present in an amount of from 0.05 to 0.8% (w/v), preferably in an amount of 0.1 to 0.4% (w/v) in the aqueous phase in step a) and the emulsifier is present in an amount of from 2 to 10% (w/v), preferably in an amount of 4 to 8% (w/v) in the organic phase in step b). In some such embodiments, it is preferable that the at least one agricultural active be present in an amount of from 3 to 10% (v/v) in the organic phase of step b), preferably >3 to 8% (v/v).

Additional components and ingredients may be included in basically any phase at any stage of the preparation method or the present invention so long as incorporation thereof does not interfere with the formation of a chitosan-coated emulsion (chitosan-stabilized emulsion) according to the present invention. For instance, but without limitation, stabilizing agents such as glycerol may be added, for instance to the aqueous phase prior to combining thereof with the organic phase. Accordingly, any such additional components and ingredients may also be present in the compositions of the invention. All embodiments pertaining to the compositions of the invention likewise and correspondingly apply to the methods of this aspect of the present invention and vice versa.

In a further aspect, the present invention relates to a chitosan-coated emulsion obtainable by a method according to the present invention, as described herein above. Also encompassed are plant treatment compositions that contain such chitosan-coated emulsions. All embodiments pertaining to the method for the preparation according to the present invention likewise and correspondingly apply to the products obtainable by said method, and vice versa.

### Uses and Methods of Use

In still another aspect, the invention is directed to the use of the plant treatment compositions according to the present invention as a plant biostimulant, antimicrobial agent, biopesticide and/or preservative, in particular in agricultural, horticultural and/or silvicultural applications, specifically for application to plants. The use may include increase of water or nutrient uptake or use efficiency, or increasing abiotic stress resistance to adverse conditions, such as drought and the like.

“Biostimulant”, as used herein, relates to compounds as defined by the European Biostimulants Industry Council as: “contain[ing] substance(s) and/or micro-organisms whose function when applied to plants or the rhizosphere is to stimulate natural processes to enhance/benefit nutrient uptake, nutrient efficiency, tolerance to abiotic stress, and crop quality.” Said effects are thus also meant and covered by the described use as biostimulant. Biostimulants act only upon a plant's vigor, offering no direct action against diseases, insects, or weeds.

Said aspect also relates to a method of stimulating natural processes to enhance/benefit nutrient uptake, nutrient efficiency, tolerance to abiotic stress, and crop quality, particularly in plants, by contacting them with (an effective amount of) the chitosan-coated emulsions or compositions of the invention. Said contacting may be by spraying or other known methods.

Alternatively or additionally, the use may include increasing the pathogen resistance of plants thus treated, for example to fungi, bacteria and viruses.

In a still further aspect, the invention thus relates to the use of a chitosan-coated emulsion according to the present invention, mixtures thereof and compositions containing it as an antimicrobial agent or biopesticide and/or for control of pests in a plant, in particular a crop plant. This use covers the growth inhibition of various pathogens, such as fungi, bacteria, viruses but also certain pests, such as insects, worms (nematodes), mites and the like.

Said aspect also covers methods for controlling pests in crops, said method comprising applying the composition of the invention to any part of the plant, the soil in which the plant is growing or is intended to grow or the seeds of the plant or as a post-harvest protection solution as well as methods for stimulating the growth or health of a plant, comprising applying the composition of the invention to any part of the plant, the soil in which the plant is growing or is intended to grow or the seeds of the plant.

Said methods and uses typically include contacting the plants with (an effective amount of) the chitosan-coated emulsions or compositions of the invention. Said contacting may be by spraying or other known methods.

The pest (controlled) may be a plant pathogenic fungus or fungus-like organisms, a plant pathogenic bacterium, or a plant pathogenic nematode.

Fungi to be controlled include without limitation Alternaria spp., Blumeria spp., Boeremia spp., Botrytis spp., Bremia spp., Cercospora spp., Cladobotryum spp., Cladosporium spp., Claviceps spp., Colletotrichum spp., Didymella spp., Erysiphe spp., Fusarium spp., Hemileia spp., Hyaloperonospora spp., Magnaporthe spp., Melampsora spp., Microdochium spp., Monilinia spp., Mycosphaerella spp., Neofabraea spp., Oculimacula spp., Penicillium spp., Peronospora spp., Phakopsora spp., Phomopsis spp., Phytophthora spp., Pilidiella spp., Plasmopara spp., Pseudoperonospora spp., Puccinia spp., Pyrenochaeta spp., Pyrenopeziza spp., Pyrenophora spp., Ramularia spp., Rhizoctonia spp., Sclerospora spp., Sclerotinia spp., Septoria spp., Sphaerotheca spp., Stagonosporopsis spp., Stemphylium spp., Taphrina spp., Ustilago spp., Venturia spp. and Verticillium spp., in particular Alternaria alternata, Alternaria brassicicola, Alternaria citri, Alternaria dauci, Alternaria solani, Alternaria tomatophila, Blumeria graminis, Boeremia exigua, Botrytis calthae, Botrytis cinerea, Botrytis fabae, Botrytis pelargonii, Botrytis pseudocinerea, Bremia lactucae, Cercospora beticola, Cladobotryum mycophilum, Cladosporium fulvum, Claviceps purpurea, Colletotrichum acutatum, Colletotrichum capsici, Colletotrichum coccodes, Colletotrichum destructivum, Colletotrichum gloeosporioides, Colletotrichum lindemuthianum, Colletotrichum orbiculare, Didymella pinodes, Erysiphe cichoracearum, Fusarium avenaceum, Fusarium culmorum, Fusarium graminearum, Fusarium oxysporum, Fusarium sambucinum, Fusarium solani, Fusarium udum, Fusarium verticillioides, Hemileia vastatrix, Hyaloperonospora parasitica, Magnaporthe oryzae, Melampsora lini, Microdochium majus, Monilinia fructicola, Monilinia laxa, Monilinia polystroma, Monilinia vaccinii-corymbosi, Mycosphaerella graminicola, Neofabraea vagabunda, Oculimacula acuformis, Oculimacula yallundae, Penicillium digitatum, Penicillium expansum, Penicillium italicum, Peronospora viciae, Phakopsora pachyrhizi, Phomopsis cucurbitae, Phomopsis obscurans, Phomopsis viticola, Phytophthora infestans, Phytophthora syringae, Pilidiella granati, Plasmopara halstedii, Plasmopara viticola, Pseudoperonospora cubensis, Puccinia graminis, Puccinia hordei, Puccinia melanocephala, Puccinia polysora, Puccinia recondita, Puccinia sorghi, Puccinia striiformis, Puccinia triticina, Pyrenochaeta lycopersici, Pyrenopeziza brassicae, Pyrenophora teres, Ramularia collo-cygni, Ramularia necator, Rhizoctonia solani, Sclerospora graminicola, Sclerotinia sclerotiorum, Septoria apiicola, Sphaerotheca fuligina, Stagonosporopsis cucurbitacearum, Stemphylium vesicarium, Taphrina deformans, Ustilago hordei, Ustilago maydis, Ustilago tritici, Venturia inaequalis, Verticillium albo-atrum and Verticillium dahlia.

Bacteria to be controlled by those uses and methods include without limitation those selected from the group consisting of: Acidovorax spp., Acidovorax spp., Agrobacterium spp., Ca. Liberibacter spp., Ca. Phytoplasma spp., Clavibacter spp., Curtobacterium spp., Dickeya spp., Erwinia spp., Pantoea spp., Pectobacterium spp., Pseudomonas spp., Ralstonia spp., Streptomyces spp., Xanthomonas spp., Xylella spp. and Xylophilus spp., in particular Acidovorax avenae, Acidovorax citrulli, Agrobacterium tumefaciens, Ca. Liberibacter africanus, Ca. Liberibacter americanus, Ca. Liberibacter asiaticus, Ca. Liberibacter solanacearum, Ca. Phytoplasma americanum, Ca. Phytoplasma mali, Ca. Phytoplasma phoenicium, Ca. Phytoplasma pruni, Ca. Phytoplasma pyri, Ca. Phytoplasma solani, Ca. spp Phytoplasma ulmi, Citrus huanglongbing, Clavibacter michiganensis, Coconut lethal yellowing phytoplasma, Curtobacterium flaccumfaciens, Dickeya dadantii, Dickeya dianthicola, Dickeya solani, Dickeya zeae, Erwinia amylovora, Erwinia carotovora, Erwinia chrysanthemi, Erwinia stewartii, Grapevine flavescence doree phytoplasma, Pantoea stewartii, Peach rosette phytoplasma, Peach yellows phytoplasma, Pectobacterium atrosepticum, Pectobacterium brasiliense, Pectobacterium carotovorum, Pectobacterium parmentieri, Pseudomonas avenae, Pseudomonas syringae, Ralstonia pseudosolanacearum, Ralstonia solanacearum, Ralstonia solanacearum, Ralstonia syzygii, Streptomyces scabiei, Xanthomonas albilineans, Xanthomonas arboricola, Xanthomonas axonopodis, Xanthomonas campestris, Xanthomonas citri, Xanthomonas cynarae, Xanthomonas euvesicatoria, Xanthomonas fragariae, Xanthomonas hortorum, Xanthomonas oryzae, Xanthomonas phaseoli, Xanthomonas translucens, Xanthomonas vesicatoria, Xylella fastidiosa and Xylophilus ampelinus.

Insect pests to be controlled by those uses and methods include without limitation those selected from the group consisting of: Diptera (flies), Lepidoptera (butterflies and moths), Coleoptera (beetles), Hemiptera (true bugs, aphids), Orthoptera (grasshoppers, crickets, and katydids), Hymenoptera (sawflies, wasps), in particular aphids (e.g green peach aphid (family: Aphididae), balsam woolly adelgid (family: Adelgidae), grape Phylloxera (family: Phylloxeridae)), scale insects (e.g. cottony cushion scales (family: Monophlebidae), soft scales (family Coccidae)), whiteflies (e.g. cabbage whitefly, greenhouse whitefly (family Aleyrodidae)), armyworms (e.g. fall army worm, true army worm, beet armyworm, pale western cutworm, army cutworm, bertha armyworm (family: Noctuidae)), beetles (e.g. colorado potato beetle, asparagus beetle (family: Chrysomelidae), sunflower headclipping weevil (family: Attelabidae), cabbage seedpod weevil, pea leaf weevil (family: Curculionidae)), true bugs (e.g. false chinch bug (family: Lygaeidae), black grass bugs (family: Miridae)), caterpillars (e.g. european corn borer (family: Pyralidae), stalk borers (family: Crambidae), cabbage moth (family: Geometridae), corn earworm moth (family: Noctuidae)), mites (e.g. spider mites (family: Tetranychidae), thread-footed mites (family: Tarsonemidae), and the gall mites (family Eriophyidae)), Thrips (e.g. onion Thrips (family: Thripidae), western flower Thrips (family: Aeolothripidae), banded flower Thrips (family: Phlaeothripidae)), sawflies (e.g. wheat stem sawfly (family: Cephidae)), flies (e.g. wheat midge (family Cecidomyiidae), and cherry fruit flies (family: Tephritidae)).

Nematodes to be controlled include without limitation those selected from the group consisting of: Aphelenchoides spp., Anguina spp., Belonolaimus spp., Ditylenchus spp., Globodera spp., Heterodera spp., Meloidogyne spp., Nacobbus spp., Pratylenchus spp., Radopholus spp., Rotylenchulus spp. and Tylenchulus spp., Xiphinema spp., in particular Aphelenchoides besseyi, Anguina tritici, Belonolaimus longicaudatus, Ditylenchus angustus, Ditylenchus dipsaci, Ditylenchus africanus, Ditylenchus destructor, Globodera pallida, Globodera rostochiensis, Heterodera avenae, Heterodera cruciferae, Heterodera filipjevi, Heterodera glycines, Heterodera schachtii, Meloidogyne arenaria, Meloidogyne chitwoodi, Meloidogyne fallax, Meloidogyne graminicola, Meloidogyne hapla, Meloidogyne incognita, Meloidogyne javanica, Nacobbus aberrans, Nacobbus dorsalis, Nacobbus serendipiticus, Pratylenchus brachyurus, Pratylenchus coffeae, Pratylenchus neglectus, Pratylenchus penetrans, Pratylenchus thornei, Pratylenchus vulnus, Pratylenchus zeae, Radopholus similis, Rotylenchulus reniformis, Rotylenchulus parvus, Tylenchulus semipenetrans, Xiphinema americanum, Xiphinema diversicaudatum, Xiphinema index and Xiphinema vuittenezi.

The plants may be agricultural plants, vegetable or fruits, optionally wheat, barley, oat, rye, soybean, corn, potatoes, oilseed rape, canola, sunflower, cotton, sugar cane, sugar beet, rice, apple, walnut, pea, Ioquat, Narcissus, cucumber, apricot, plum, peach, beans, mushrooms, grapevine, Dianthus, Citrus fruit, spinach, lettuce, tomato, asparagus, cabbages, sorghum, pear, strawberry, sweet pepper, carrot, onion, celery, blackberry, linseed, or leek; a silvicultural plant; an ornamental plant; or a horticultural plant.

Various publications and/or references have been cited herein, the content of which are incorporated herein by reference.

### EXAMPLES

### Chitosans

The chitosans used in the following examples are only to be considered as illustrative and can be replaced by other suitable chitosan polymers and oligomers with random or non-random PA, DA up to 30% and molecular weight (Mw, <500 kDa) produced chemically or enzymatically. The characteristics of different chitosans used herein are summarized in Table 1.

TABLE 1
Characteristics of exemplary chitosans used

| | DA | Mw | | |
|---|---|---|---|---|
| Chitosan | [%] | [kDa] | PA | Polymer/Oligomer |
| CS1 | 20 | 136 | random | Polymer |
| CS2 | 20 | 60 | random | Polymer & Oligomer |
| | | | | mixture |
| CS3 | 30 | 145 | non-random | Polymer |
| | | | (patented- | |
| | | | EP3810660A1) | |

### CODIFICATION/ABBREVIATIONS

n-CSm n=1,2,4 mg/mL of chitosan; m=1,2,3 indicating the type of chitosan used (see Table 1 below)
xPO x=3-10% (v/v) of peppermint oil
PO Peppermint oil
SP Spearmint oil
GR Geraniol
EU Eugenol
TH Thymol
CO Clove oil

The following terminology is used to designate the chitosan used:
e.g.: 2-CS1-3PO stands for 2 mg/mL of CS1 (random PA, 20% DA and 136 kDa Mw) with 3% (v/v) peppermint oil

Formulations are prepared using method 1 as described below, if not indicated otherwise.

### Example 1: Method of Preparation 1

### Aqueous Phase (20 mL):

Chitosan: 20 mL of 0.05%-0.2% (w/v)

### Organic Phase (10 mL):

1. Lipophilic molecule: 3%-10% (v/v)
2. Lecithin: 4%-8% (w/v)
3. Miglyol 812 (M): 0%-1.25% (v/v)
4. Ethanol: required amounts used to make up the volume to 10 mL

The organic phase was poured into the aqueous phase to produce 30 mL intermediate of chitosan-coated peppermint emulsion. The emulsions was formed spontaneously upon mixing at room temperature. 30 mL was further reduced to 10 mL using a R-300 Rotavapor (Buchi Labortechnik GmbH, Essen, Germany).

### Example 2: Method of Preparation 2

### Aqueous Phase (20 mL):

Chitosan: 20 mL of 0.1%-0.4% (w/v)

### Organic Phase (10 mL):

1. Lipophilic molecule: 3%-10% (v/v)
2. Lecithin: 4%-8% (w/v)
3. Miglyol 812 (M): 0%-1.25% (v/v)
4. Ethanol: required amounts used to make up the volume to 10 mL

The organic phase was poured into the aqueous phase to produce 30 mL intermediate of chitosan-coated peppermint emulsion. The emulsion was formed spontaneously upon mixing at room temperature. 30 mL was further reduced to 20 mL using a R-300 Rotavapor (Buchi Labortechnik GmbH, Essen, Germany).

In both methods described (Example 1 and 2), formulations can also be prepared by adjusting the initial concentrations and volumes of ingredients to avoid ethanol evaporation.

### Example 3: Physiochemical Characterization

### Varying Oil Concentrations

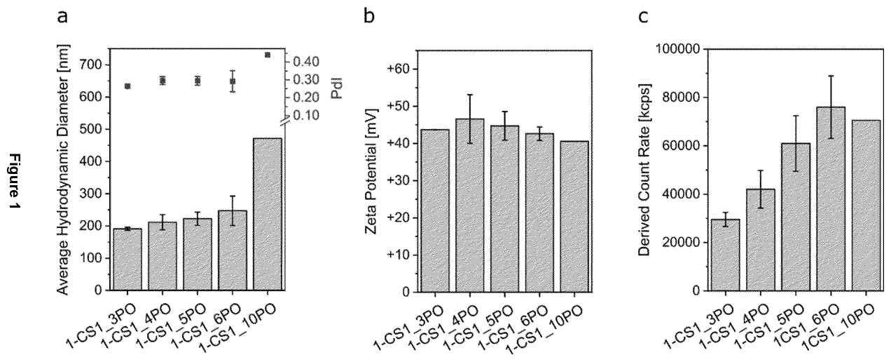

Peppermint oil was used as a model to study the effect of varying v/v % (3-10%) of oil in the formulation. The physicochemical characterization provided in FIG. 1 shows that within the studied concentration range, the characteristics such as hydrodynamic diameter, polydispersity index (Pdl), zeta potential, and derived count rate are within the desired limits for all samples except for 1-CS1_10PO where polydispersity was >0.4, making it unsuitable for our applications.

### Varying Chitosan Types

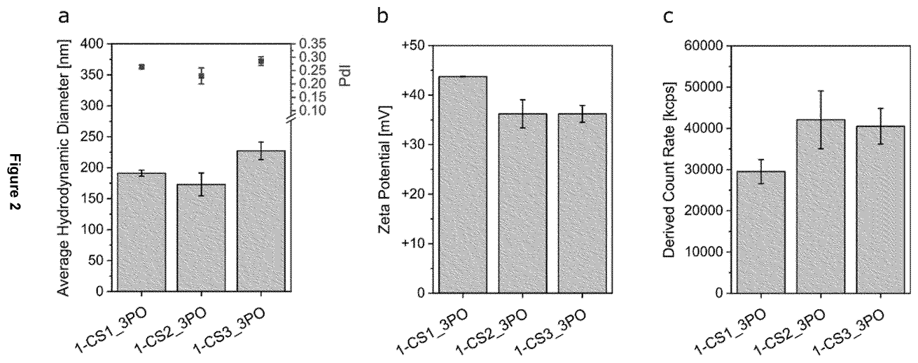

3% (v/v) PO formulation was prepared by varying the type of chitosan used. The characterization shown in FIG. 2 confirms the ability to vary the type of chitosan used to produce the formulation without altering the desired characteristics of the formulation.

### Varying Chitosan Concentrations

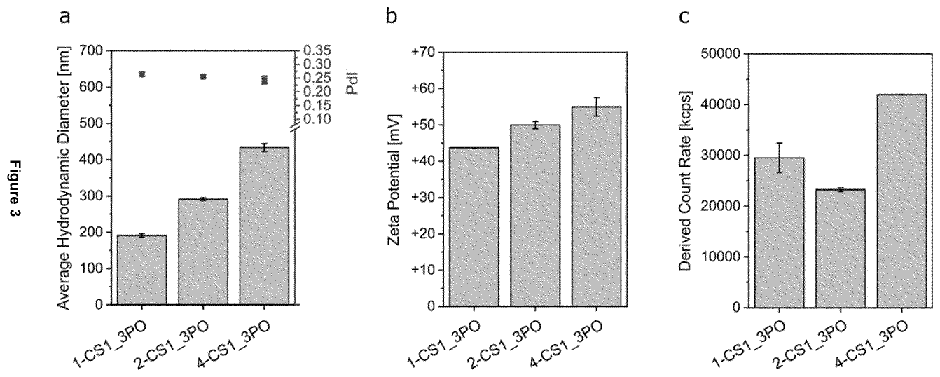

3% (v/v) PO emulsion coated with chitosan was further studied by varying the chitosan concentration—0.1%, 0.2% and 0.4% (w/v). As the concentration of chitosan increased in the formulation, an increase in size and zeta potential was observed (FIG. 3) indicating the deposition of chitosan on the surface of the emulsion droplet.

### Varying Plant-Based Ingredients in the Core

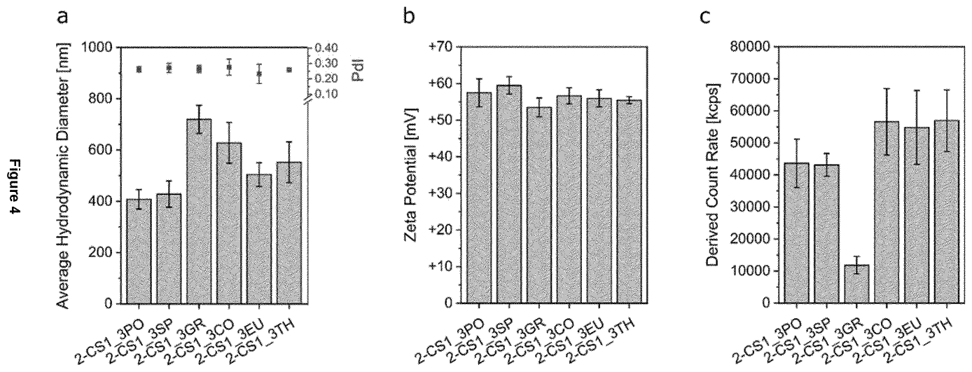

Physicochemical characteristics of some selected formulations (prepared with chitosan CS1 at 0.2% (v/w) and different lipophilic molecules in the core (3% (v/v)): peppermint oil (PO), spearmint (SP), geraniol (GO) with glycerol, clove oil (CO), eugenol (EU) in miglyol, and thymol (TH) in miglyol) are presented in FIG. 4 as a proof of the versatility of the technology that enables the incorporation of various plant-based agricultural actives, e.g., essential oils, terpenes, etc., as herein defined. For some molecules such as eugenol, thymol and geraniol, the addition of miglyol or glycerol improves the formulation stability.

### Long Term Stability

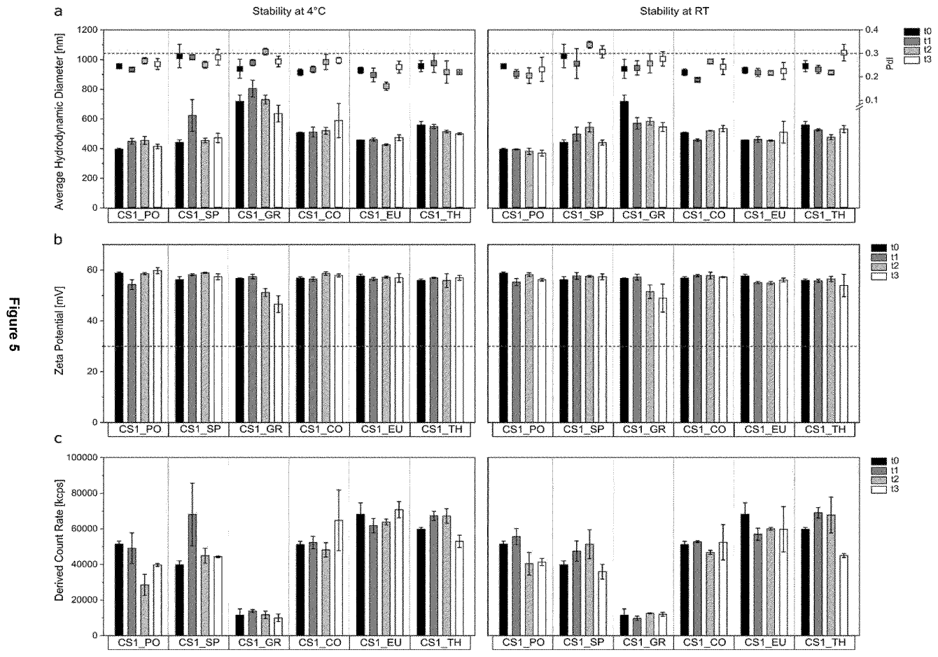

Stability studies were performed for selected formulations for three months stored at room temperature (RT) and at 4 °C. During this period, the formulations were studied for visual changes (e.g., color, creaming, sedimentation, phase separation) as well as for their physicochemical characteristics every four weeks. As seen in FIG. 5, the formulations maintained all the quality thresholds desired through three months of storage with no changes in physical appearance.

### Morphology

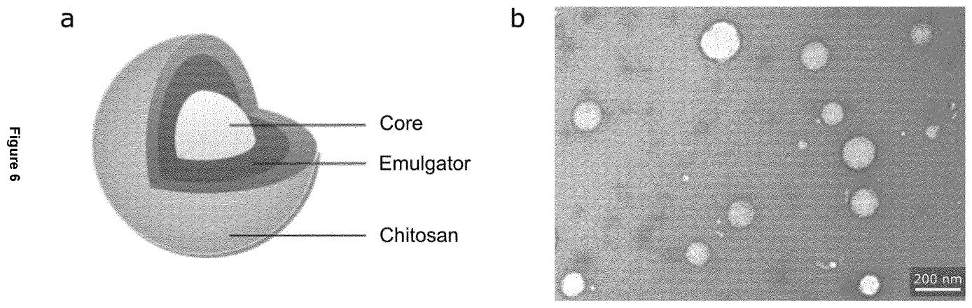

FIG. 6 shows the transmission electron micrograph of one of the formulations. The image obtained validated the expected spherical morphology with a ring of chitosan around the emulsion droplet.

### Example 4: Bioactivity of Formulations

Antifungal activity against Fusarium graminearum and Botrytis cinerea B05.10 The antifungal activity of selected formulations was tested against two model plant pathogenic fungi, Fusarium graminearum, known to cause head blight diseases in wheat, corn, and barley and Botrytis cinerea B05.10 (gray mold), a necrotrophic fungus that infects a wide range of plant species and presents a significant problem in horticultural crops.

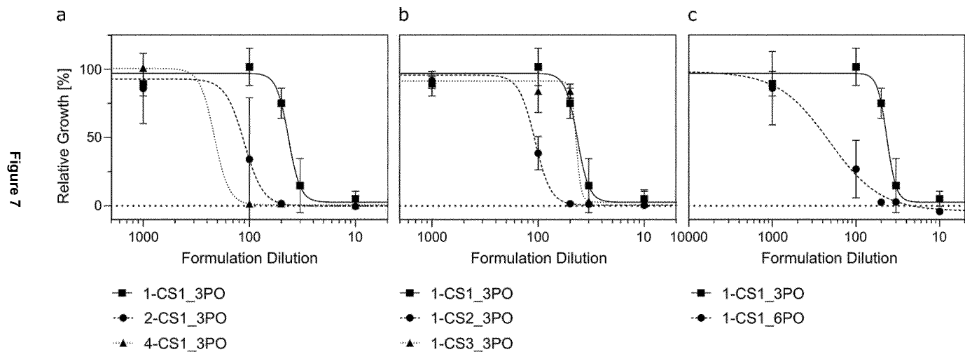

In a 96-well-microtiter plate, chitosan-coated formulations at different concentrations were added to the medium followed by F. graminearum spores (~70 spores/well). Fungal growth was determined by measuring OD_{600 nm} at day four. All formulations with chitosan concentration of 0.1% to 0.4% (w/v) showed high antifungal activity (FIG. 7a). As desired, a higher concentration of chitosan in the formulation led to an increase in the anti-fungal activity with 0.4% (w/v) CS1 showing the strongest effect, closely followed by 0.2% (w/v) CS1 formulation.

Furthermore, antifungal activity of formulations with two commercially available chitosans (CS1 and CS2) and one enzymatically (lab-made) produced chitosan with a blockwise PA (CS3) was determined (FIG. 7b). All three formulations were able to inhibit the growth of the fungus. However, 1-CS2_3PO showed a significantly higher antifungal activity in comparison to the formulations containing the other two chitosans.

Additionally, formulations prepared with a constant concentration of chitosan (CS1) but with a higher peppermint oil concentration (6% (v/v)) resulted in a stronger antifungal activity in comparison to 3% (v/v) as shown in FIG. 7c.

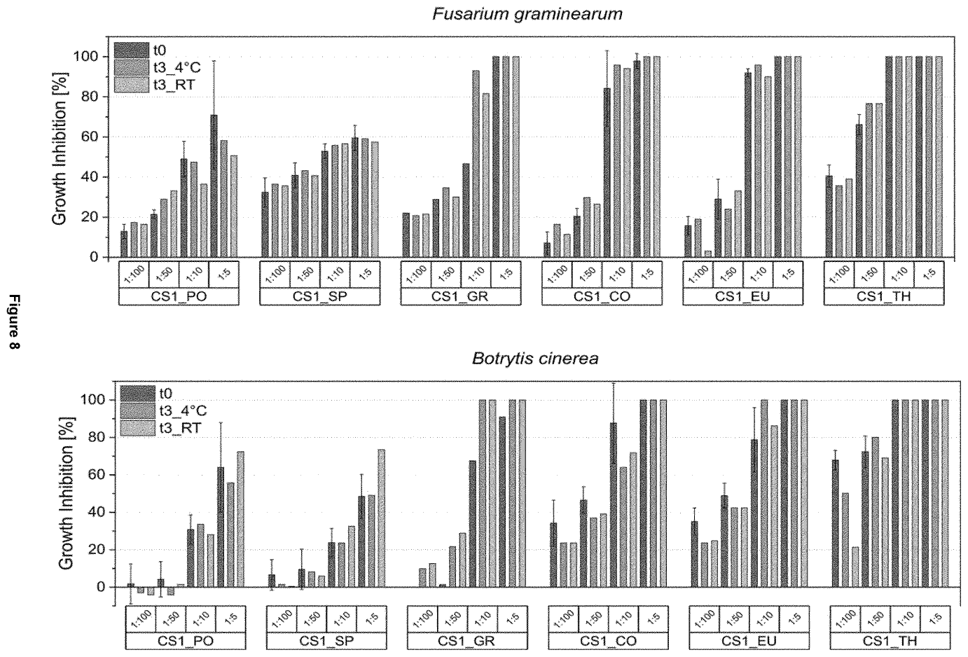

Besides the in vitro liquid assay, the antifungal activity of formulations stored for 3 months at RT and 4 °C was tested against F. graminearum and B. cinerea using a radial growth assay. For this purpose, the surface of the CM-agar (d=8.5 cm) was treated with 1 mL of varying concentrations (by dilution with water) of the formulations after which 5 μL of spore-suspension (containing ~350 spores) was placed in the center of the plate. Fungal growth was determined by measuring the diameter of the mycelium after four days of incubation at 26 °C. The growth of the fungus was inhibited by all the formulations compared to the water control as shown FIG. 8. All formulations were stable and showed no loss in activity after 3 months of storage at RT or 4 °C. The strongest inhibition against F. graminearum and B. cinerea could be observed for formulations containing thymol (CS1_TH), eugenol (CS1_EU), and clove oil (CS1_CO).

Germination Inhibition of F. graminearum Macroconidia in the Presence of Clove Oil Formulation

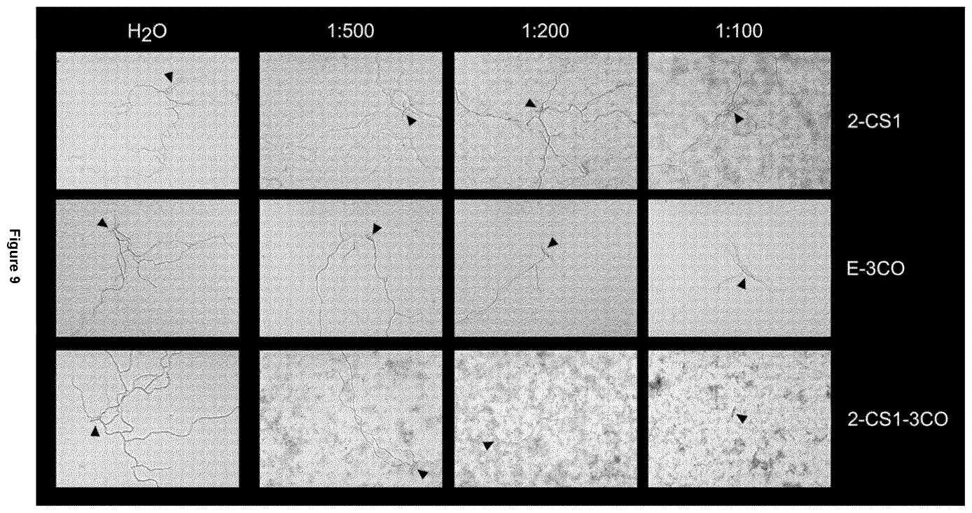

To determine the germination inhibition of F. graminearum macroconidia in the presence of clove oil-containing formulation, the macroconidia were incubated for 24 h in CM-medium in the presence of 2-CS1_3CO, chitosan CS1, or the corresponding emulsion E_3CO. The germination was completely inhibited by the formulation at a concentration of 20 μg/mL CS1 and 0.03% (v/v) CO, whereas the treatment with only CS1 or emulsion containing CO at the same concentrations did not influence the germination of macroconidia (FIG. 9).

Antibacterial Activity Against Pseudomonas syringae pv. tomato DC3000

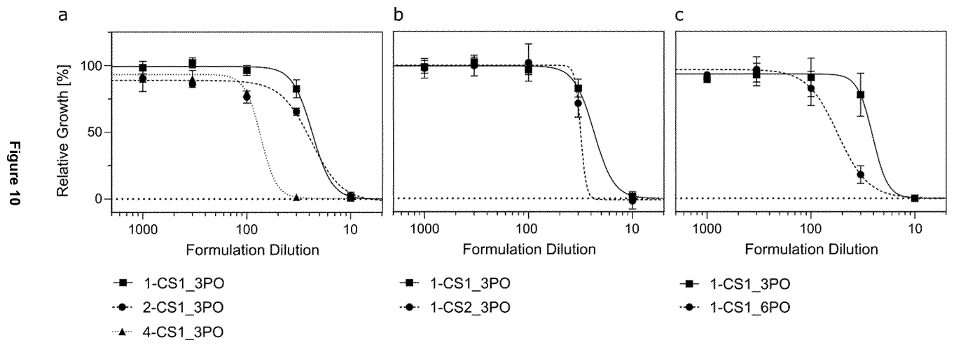

The antibacterial activity of selected formulations was tested against the plant pathogenic bacteria Pseudomonas syringae pv. tomato DC3000 in a liquid assay performed in a 96-well-microtiter plate. Bacterial growth was determined by measuring OD_{600 nm} over a period of 24 hours. All formulations with chitosan concentrations of 0.1% to 0.4% (w/v) showed an antibacterial activity, with 0.4% (w/v) CS1 showing the strongest inhibition (FIG. 10a). When comparing the antibacterial activity of formulations with different types of chitosans, it was seen that CS2 had a slightly stronger activity (FIG. 10b). Finally, the antibacterial activity of the formulation also improved further when increasing the PO concentration from 3% to 6% (v/v) (FIG. 10c).

### Nematicide Activity Against Meloidogyne Spec.

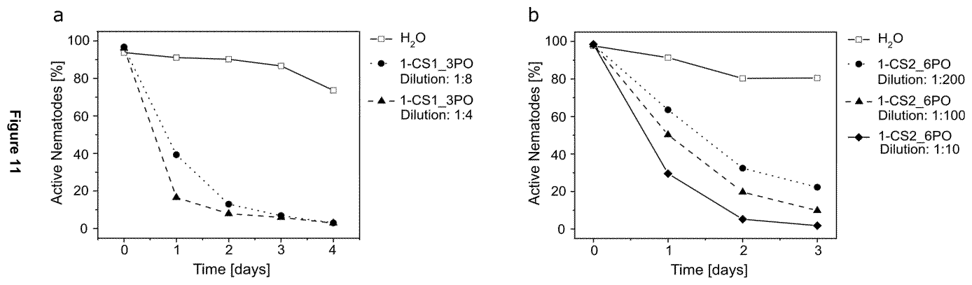

In addition to the antimicrobial properties of the formulations, the activity of selected formulations was tested against different species of the plant parasitic nematode Meloidogyne. The ability of the formulations to immobilize juveniles (J2) of Meloidogyne spec., which were placed in a 24-well-plate, was determined by counting the active and inactive juveniles every 24 h. It was observed that the formulations containing 3% and 6% (v/v) peppermint oil were able to inactivate juveniles of M. incognita after two days (FIG. 11).

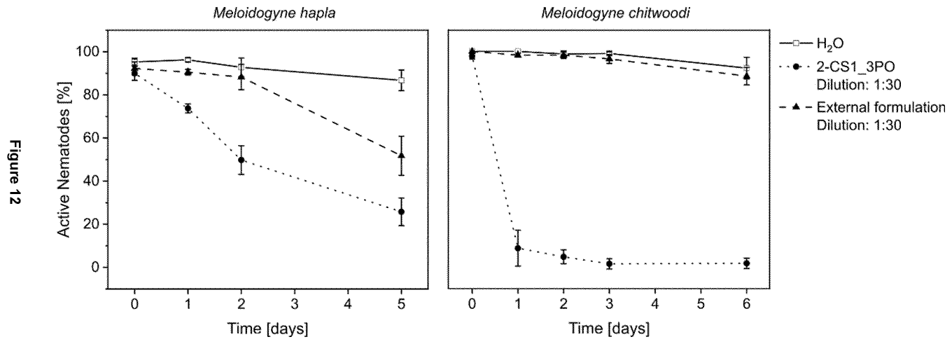

The nematicidal activity of 2-CS1_3PO was tested against the quarantine nematodes M. chitwoodi and M. hapla (FIG. 12). The results were compared to an externally developed formulation consisting of different chitosan and peppermint oil. It is evident from FIG. 12 that the formulation 2-CS1_3PO was effective against both M. chitwoodi (complete inhibition) and M. hapla (>70% inhibition) whereas the external formulation despite containing similar ingredients failed to inactive M. chitwoodi and was less effective against M. hapla. This experiment provides strong evidence for the importance of selection of the right ingredients as well as the need for a technology that can effectively combine the two ingredients.

### Plant-Strengthening Activity

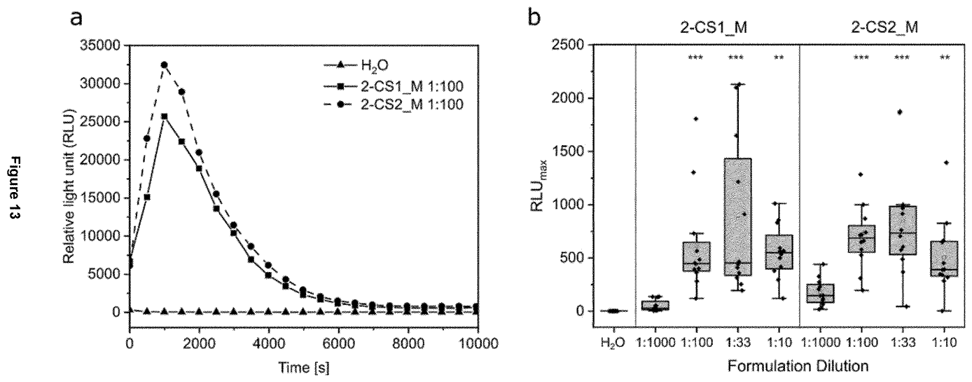

Experiments were conducted to validate the plant-immune strengthening activity of the formulations. To this end, experiments were conducted to validate the retention of the plant-eliciting activity of chitosan even after being used as a coating agent on the emulsions. To determine this, the elicitor activity of the formulations was measured in a leaf disc assay with potato plants (Solanum tuberosum cv. Sarpo mira) (FIG. 13). Elicitor-active substances can be identified using a chemiluminescence-based method that measures the reactive oxygen species released from leaf discs when treated with an elicitor active component. Formulations containing the chitosan CS1 and CS2 displayed a high eliciting activity. This indicates that the chitosan used in the formulation is also perceived by the plant receptors and can trigger an immune response.

### Synergistic Activity of Chitosan and Different Core Substances in the Formulation

To determine the synergistic activity, the antifungal activity of the individual components (chitosan and emulsion) was measured and compared to the activity of the corresponding formulations (1-CS1_6PO and 1-CS2_6PO prepared with chitosan CS1 and CS2 and peppermint oil (PO); 2-CS2_3GO prepared with CS2 and geraniol (GO); and 2-CS2_3EU prepared with CS2 and eugenol (EU)). The synergistic activity was calculated using Abbott's formula.

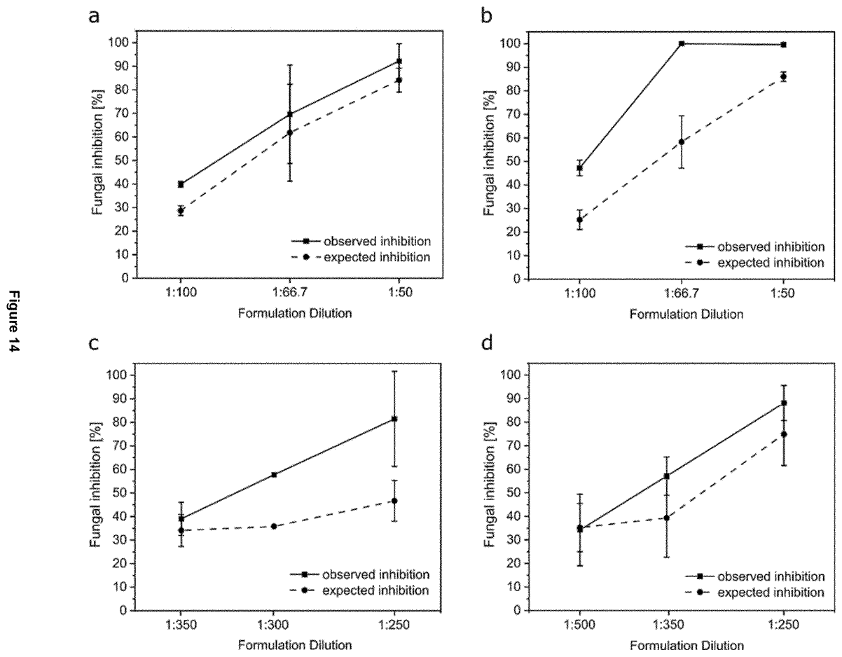

Irrespective of the plant-based lipophilic ingredient in the core of the emulsion, all tested formulations displayed a synergistic effect. The overview of the expected and observed effects of each of the tested formulations is provided in Table 2 and in FIG. 14.

TABLE 2
Synergistic activity calculation via Abbott's formula. The synergy
factor (SF) is the ratio of the observed inhibition C_{obs} to the expected inhibition
Cₑₓₚ with synergistic activity represented by SF > 1.

| | | | | | | | Synergy |
|---|---|---|---|---|---|---|---|
| | | Formulation | c Chitosan | c EO | | | Factor |
| Chitosan | EO | Dilution | [μg/ml] | [%] | Cₑₓₚ | C_{obs} | (C_{obs}/Cₑₓₚ) |
| CS1 | PO | 1:100 | 10 | 0.06 | 28.7 | 39.9 | 1.4 |
| | | 1:66.7 | 15 | 0.09 | 61.8 | 69.6 | 1.1 |
| | | 1:50 | 20 | 0.12 | 84.1 | 92.2 | 1.1 |
| CS2 | PO | 1:100 | 10 | 0.06 | 25.2 | 47.2 | 1.9 |
| | | 1:66.7 | 15 | 0.09 | 58.3 | 100 | 1.7 |
| | | 1:50 | 20 | 0.12 | 86.0 | 99.6 | 1.2 |
| CS2 | GO | 1:350 | 5.7 | 0.009 | 34.1 | 39.1 | 1.1 |
| | | 1:300 | 6.7 | 0.01 | 35.8 | 57.8 | 1.6 |
| | | 1:250 | 8 | 0.012 | 46.6 | 74.4 | 1.6 |
| CS2 | EU | 1:500 | 4 | 0.006 | 35.2 | 34.2 | 1.0 |
| | | 1:350 | 5.7 | 0.09 | 39.3 | 57.1 | 1.5 |
| | | 1:250 | 8 | 0.012 | 74.9 | 88.1 | 1.2 |

Active ingredients (AI): PO = peppermint oil; GR = geraniol in miglyol; EU = eugenol in miglyol; chitosans CS1 (DA 20%, Mw 136 kDa) and CS2 (DA 20%, Mw 60 kDa).

### In Vivo Activity of Chitosan-Stabilized Clove Oil Formulation

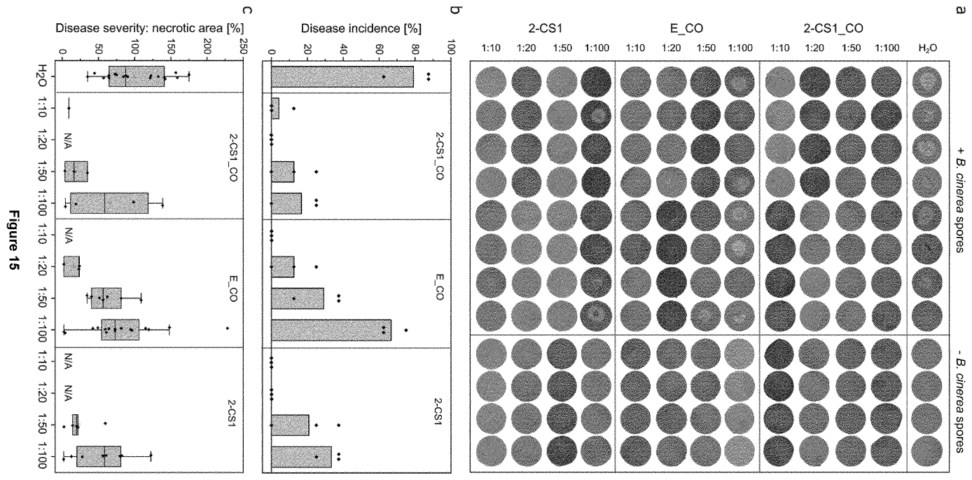

To analyze the in vivo activity of the chitosan-stabilized clove oil formulation a leaf disc assay with the pathosystem bean (Phaseolus vulgaris)—B. cinerea was used. P. vulgaris is a common host to study the virulence of B. cinerea. Leaf discs were punched out from 12-day-old bean plants, placed on water agar plates, and inoculated with B. cinerea by placing a 7 μL spore solution droplet (10.000 spores/mL) in the center of the leaf disc. The sealed plates were incubated at 21 °C and 1 dpi the leaf discs were treated with different dilutions of the treatment solution on the disc surface. At 4 dpi the leaf discs were evaluated. An overview of the leaf discs at the end of 4 dpi is shown in FIG. 15a.

The disease incidence reflects the number of infected leaf discs in % (FIG. 15b). When the discs were treated with the formulation 2-CS1_CO the disease incidence remained below 20% for all tested dilutions. With the dilution of 1:10 and 1:20 an infection with B. cinerea could be avoided completely. The clove oil formulation at 1:100 dilution showed the best effect compared to the emulsion and the chitosan CS1 alone. The disease severity was assessed within the infected leaf discs by measuring the necrotic area and normalising it to water control. In FIG. 15c it is visible, that among the infected leaf discs, the size of the necrotic area reduced after treatment with the formulation 2-CS1_CO and with the chitosan CS1 (1:10, 1:20, 1:50).

While particular embodiments of the present invention have been illustrated and described, it would be obvious to those skilled in the art that various other changes and modifications can be made without departing from the scope of the invention. It is therefore intended to cover in the appended claims all such changes and modifications that are within the scope of this invention.

1. Plant treatment composition comprising a chitosan-coated emulsion, said chitosan-coated emulsion being an o/w emulsion comprising
(1) a continuous aqueous phase; and
(2) a dispersed phase in form of droplets dispersed in the continuous phase, wherein each droplet is at least partially coated with at least one chitosan and comprises at least one agricultural active, optionally at least one emulsifier, and optionally at least one carrier (oil).

2. The plant treatment composition of claim 1, wherein the at least one agricultural active has pesticidal and/or plant stimulating activity.

3. The plant treatment composition of claim 1 or 2, wherein
(1) the at least one agricultural active is selected from the group consisting of plant extracts, plant-derived molecules or mixtures thereof; and/or
(2) the at least one agricultural active is selected from a fungicide, an insecticide, a herbicide, a bactericide, a nematicide, and/or a plant growth regulator, preferably a fungicide.

4. The plant treatment composition of any one of claims 1 to 3, wherein the at least one agricultural active is
(1) a fungicide, preferably selected from aminopyridines, preferably fluazinam; anilinopyrimidines, preferably cyprodinil; benzamides, preferably fluopyram; conazoles, preferably epoxiconazole or hexaconazole; dioxazines, preferably fluoxastrobin; imidazoles, preferably imazalil; morpholines, preferably dimethomorph or fenpropidine; phenylpyrroles, preferably fludioxonil; phthalonitriles, preferably chlorothalonil; pyrazoles, preferably benzovindiflupyr, bixafen, fluxapyroxad or penthiopyrad; pyridinecarboxamides, preferably boscalid; pyrimidines, preferably bupirimate; strobilurins, preferably azoxystrobin, trifloxystrobin or pyraclostrobin; and triazoles, preferably tebuconazole or metconazole;
(2) an insecticide, preferably selected from the group consisting of benzoyl ureas, preferably novaluron, lufenuron, chlorfluazuron, flufenoxuron, hexaflumuron, noviflumuron, teflubenzuron, triflumuron or diflubenzuron; carbamates; pyrethroids, preferably cyhalothrin or isomers or isomer mixtures thereof, lambda-cyhalothrin, deltamethrin, tau-fluvalinate, cyfluthrin, beta-cyfluthrin, tefluthrin, or bifenthrin; organophosphates, preferably azinfos-methyl, chlorpyrifos, or diazinon; endosulfan; methidathion; neonicotinoids; and phenylpyrazoles, preferably imidacloprid, acetamiprid, thiacloprid, dinotefuran, thiamethoxam or fipronil;
(3) a nematicide, preferably selected from the group of fluopyram; fluensulfone; 1,3-dichloropropene; abamectin; emamectin benzoate; fenamiphos; and azadirachtin;
(4) a herbicide, preferably selected from the group consisting of aryloxyphenoxy derivatives; aryl ureas; aryl carboxylic acids; aryloxy alkanoic acid derivatives; preferably clodinafop-propargyl and analogues thereof, fenoxaprop-p-ethyl and analogues thereof, propaquizafop, quizalafop and analogues thereof; dinitroanilines, preferably pendimethalin and trifluralin; diphenyl ethers, preferably oxyfluorfen; imidazolinones; sulfonylureas, preferably chlorsulfuron, nicosulfuron, rimsulfuron, tribenuron-methyl; sulfonamides; triazines; and triazinones, preferably metamitron;
(5) selected from the group of essential oils, individual components of essential oils, and mixtures thereof.

5. The plant treatment composition of claim 4(5), wherein the essential oil is selected from the group consisting of allspice oil, ambrette seed oil, amyris oil, Angelica root oil, anise oil, anthopogon oil, arborvitae oil, basil oil, bay laurel oil, beeswax absolute, bergamot oil, bergamot mint oil, bitter orange oil, black pepper oil, black spruce oil, blood orange oil, blue cypress oil, blue spruce oil, blue tansy oil, bois de rose oil, Boronia absolute, Bursera graveolens oil, cade oil, cajeput oil, camphor oil, Cananga oil, Cannabis oil, cardamom oil, carrot seed oil, Cassia oil, castor oil, catnip oil, cedar oil, chamomile oil, cilantro oil, cinnamon oil, Cistus oil, Citrus oil, citronella oil, clary sage oil, clove oil, coffee oil, common sage oil, copaiba balsam oil, coriander oil, corn oil, cornmint oil, cottonseed oil, cubeb oil, cumin oil, cypress oil, davana oil, dill oil, elemi oil, Eucalyptus oil, fennel oil, fir oil, fragonia oil, frankincense oil, Galbanum oil, garlic oil, geranium oil, ginger oil, goldenrod oil, grapefruit oil, greenland moss oil, gurjum balsam oil, helichrysum oil, hemp oil, hinoki oil, ho oil, hops oil, hyssop oil, ishpingo oil, lavender oil, jasmin oil, juniper oil, Kunzea oil, laurel oil, lavandin oil, lavender oil, ledum oil, lemon oil, lemon balm oil, lemon Eucalyptus oil, lemongrass oil, lemon myrtle oil, lemon tea tree oil, lemon Verbena oil, lime oil, linden oil, linseed oil, mandarin oil, manuka oil, marjoram oil, may chang oil, melissa oil, mint oil, myrrh oil, myrtle oil, neem oil, neroli oil, niaouli oil, nutmeg oil, oakmoss oil, onion oil, opoponax oil, orange oil, oregano oil, palmarosa oil, palo santo oil, parsley oil, patchouli oil, peppermint oil, pink pepper oil, peru balsam oil, petitgrain oil, pimento oil, pine oil, plai oil, pomelo oil, Rhododendron oil, Rosalina oil, rose oil, rosemary oil, rosewood oil, sage oil, sandalwood oil, saro oil, Sassafras oil, spearmint oil, spikenard oil, spruce oil, star anis oil, Styrax benzoin absolute, sweet orange oil, Tagetes oil, tangerine oil, tea tree oil, thyme oil, tobacco oil, tuberose oil, tulsi oil, valerian oil, vanilla oil, vetiver oil, violet oil, white tea tree oil, wintergreen oil, xanthoxylum oil, yarrow oil, ylang ylang oil, yuzu oil, mixtures thereof, and individual components thereof.

6. The plant treatment composition of claim 5, wherein said individual components of an essential oil are selected from the group of (+/−)-bornyl acetate, (+/−)-carveol, (+/−)-caryophyllene oxide, (+/−)-citronellal, (+/−)-dihydrocarvyl acetate, (+/−)-fenchone, (+/−)-isopinocampheol, (+/−)-isopulegol, (+/−)-menthone, (+/−)-menthyl acetate, (+/−)-myrtenol, (+/−)-perillylalcohol, (+/−)-trans-myrtanol, (+/−)-verbenone, (+)-2-carene, (+/−)-cuparene, (+/−)-dihydrocarveol, (+/−)-dihydrocarvone, (+/−)-isomenthol, (+/−)-borneol, (+/−)-alpha-pinene, (+/−)-beta-pinene, (+/−)-beta-citronellol, (+/−)-camphor, (+/−)-linalool, (+/−)-menthol, (+/−)-neomenthol, (1R)-chrysanthemolactone, (1S,2S)-10-pinanol, (cis/trans)-nerolidol, 1,4-cineole, 1,8-cineole, 2-isopropyl-5-methylphenol (thymol), 2-norbornanone, 3-carene, 3-octanone, 4-menthan-3-one, acetic acid butylester, 2-phenylethyl propionate, acetic acid cinnamylester, acetic acid heptylester, acetic acid isobutylester, acetic acid methylester, alpha-(−)-bisabolol, alpha-caryophyllene, alpha-cedrene, alpha-humulene, alpha-ionone, alpha-terpinene, alpha-terpineol, azulene, benzoic acid eugenylester, beta-cedrene, beta-naphthol, beta-thujaplicin, butyl acetate, cajeputol, camphene, cedar camphor, cedrol, chamazulen, cinnamyl acetate, cis-jasmone, cis-nerolidol, citral, citronellol, cuminaldehyde, cypress camphor, dihydrocarveol, dillapiole, DL-citronellyl acetate, estragole, eucalyptol, eugenol methylether, eugenylbenzoate, exo-2-camphanol, farnesol, furfuryl acetate, furfuryl alcohol, gamma-terpinene, geranyl acetate, geraniol, heptyl acetate, isobornyl acetate, isobornyl isovalerate, isobutyl acetate, isocineole, isoeugenol, isoeugenylacetate, isolongifolene, isomenthone, isothymol, lemonol, linalool oxide, linalyl acetate, nerol, nootkatone, p-allylanisole, piperitone, R-(−)-alpha-phellandrene, R-(+)-limonene, R-(+)-pulegone, S-(−)-limonene, sabinene, sabinyl acetate, terpinolene, terpinyl acetate, tetrahydrolinalool, trans-nerolidol, trans-stilbene, eugenol, and lavendulol.

7. The plant treatment composition of any one of claims 1 to 6, wherein the at least one chitosan is selected from chitosan polymers and/or polymer-oligomer mixture with random or non-random pattern of acetylation (PA) and mixtures thereof.

8. The plant treatment composition of any one of claims 1 to 7, wherein the at least one chitosan has
a degree of acetylation (DA) of up to 30, preferably 10 to 30; and/or
a degree of polymerization (DP) of up to 5000, preferably up to 1200; and/or
an average molecular weight Mw of <900.000 g/mol, optionally <200.000 g/mol.

9. The plant treatment composition of any one of claims 1 to 8, wherein the at least one chitosan is a chitosan polymer or a mixture of chitosan polymers and oligomers, wherein the chitosan polymers and oligomers independently of each other have a degree of acetylation (DA) of up to 30, preferably 10 to 30, and wherein the chitosan polymers have a Mw of 40.000 to 100.000 g/mol, preferably 50.000 to 80.000 g/mol, more preferably 55.000 to 65.000 g/mol and wherein the chitosan oligomers have a degree of polymerization (DP) of 2 to 30.

10. The plant treatment composition of any one of claims 1 to 9, wherein the at least one emulsifier is selected from the group consisting of monoglycerides, sorbitan esters, alkylene glycol esters such as propylene glycol esters, phospholipids such as lecithins, polysorbates, sucrose esters of medium chain saturated fatty acids, sucrose esters of long chain saturated fatty acids, and sucrose esters of unsaturated fatty acids.

11. The plant treatment composition of any one of claims 1 to 10, wherein the chitosan-coated emulsion comprises at least one carrier (oil) selected from the group consisting of synthetic or natural oils comprising free fatty acids, mono-, di- and triglycerides, fatty acid ethyl esters, or a combination thereof.

12. The plant treatment composition of any one of claims 1 to 11, comprising the at least one chitosan in an amount of from 0.001 to 50% (w/w), preferably in an amount of 0.005 to 10% (w/w), more preferably in an amount of 0.01 to 1% (w/w) relative to the total weight of the emulsion.

13. The plant treatment composition of any one of claims 1 to 12, wherein the at least one emulsifier is comprised in the emulsion in an amount of from 0.001 to 50% (w/w), preferably in an amount of 0.005 to 10% (w/w), more preferably in an amount of 0.01 to 5% (w/w) relative to the total weight of the emulsion.

14. The plant treatment composition of any one of claims 1 to 13, wherein the chitosan-coated emulsion comprises at least one carrier (oil) in an amount of from 0.0001 to 95% (w/w), preferably in an amount of 0.001 to 70% (w/w), more preferably in an amount of 0.01 to 50% (w/w) relative to the total weight of the emulsion.

15. The plant treatment composition of any one of claims 1 to 14, wherein the at least one agricultural active is comprised in an amount of from 0.0001 to 90% (w/w), preferably in an amount of 0.001 to 70% (w/w), more preferably in an amount of 0.01 to 50% (w/w) relative to the total weight of the emulsion.

16. The plant treatment composition of any one of claims 1 to 15, wherein the plant treatment composition is an agricultural composition, a horticultural composition, a silvicultural composition or a pesticide composition.

17. Use of the plant treatment composition of any one of claims 1 to 15 as a plant biostimulant, antimicrobial agent, biopesticide and/or preservative in agricultural, horticultural and/or silvicultural applications.

18. Use of the plant treatment composition according to any one of claims 1 to 15 for the control of pests in a plant.

19. Method for controlling pests in crops, comprising applying the composition according to any one of claims 1 to 15 to any part of the plant, the soil in which the plant is growing or is intended to grow or the seeds of the plant for post-harvest protection.

20. Method for stimulating the growth or health of a plant, comprising applying the composition according to any one of claims 1 to 15 to any part of the plant, the soil in which the plant is growing or is intended to grow or the seeds of the plant.

21. The use of claim 17 or 18 or the method of claim 19 or 20, wherein the pest is a plant pathogenic fungus or fungus-like organisms, a plant pathogenic bacterium, a plant pathogenic nematode, or an insect.

22. The use or method of claim 21, wherein the fungus is selected from the group consisting of Alternaria spp., Blumeria spp., Boeremia spp., Botrytis spp., Bremia spp., Cercospora spp., Cladobotryum spp., Cladosporium spp., Claviceps spp., Colletotrichum spp., Didymella spp., Erysiphe spp., Fusarium spp., Hemileia spp., Hyaloperonospora spp., Magnaporthe spp., Melampsora spp., Microdochium spp., Monilinia spp., Mycosphaerella spp., Neofabraea spp., Oculimacula spp., Penicillium spp., Peronospora spp., Phakopsora spp., Phomopsis spp., Phytophthora spp., Pilidiella spp., Plasmopara spp., Pseudoperonospora spp., Puccinia spp., Pyrenochaeta spp., Pyrenopeziza spp., Pyrenophora spp., Ramularia spp., Rhizoctonia spp., Sclerospora spp., Sclerotinia spp., Septoria spp., Sphaerotheca spp., Stagonosporopsis spp., Stemphylium spp., Taphrina spp., Ustilago spp., Venturia spp. and Verticillium spp.

23. The use or method of claim 21, wherein the bacterium is selected from the group consisting of: Acidovorax spp., Acidovorax spp., Agrobacterium spp., Ca. Liberibacter spp., Ca. Phytoplasma spp., Clavibacter spp., Curtobacterium spp., Dickeya spp., Erwinia spp., Pantoea spp., Pectobacterium spp., Pseudomonas spp., Ralstonia spp., Streptomyces spp., Xanthomonas spp., Xylella spp. and Xylophilus spp.

24. The use or method of claim 21, wherein the nematode is selected from the group consisting of: Aphelenchoides spp., Anguina spp., Belonolaimus spp., Ditylenchus spp., Globodera spp., Heterodera spp., Meloidogyne spp., Nacobbus spp., Pratylenchus spp., Radopholus spp., Rotylenchulus spp. and Tylenchulus spp., Xiphinema spp.

25. The use or method of claim 21, wherein the insect is selected from the group consisting of: Diptera (flies), Lepidoptera (butterflies and moths), Coleoptera (beetles), Hemiptera (true bugs, aphids), Orthoptera (grasshoppers, crickets, and katydids), and Hymenoptera (sawflies, wasps).

26. The use or method of claim 22, wherein the fungus is selected from the group consisting of: Alternaria alternata, Alternaria brassicicola, Alternaria citri, Alternaria dauci, Alternaria solani, Alternaria tomatophila, Blumeria graminis, Boeremia exigua, Botrytis calthae, Botrytis cinerea, Botrytis fabae, Botrytis pelargonii, Botrytis pseudocinerea, Bremia lactucae, Cercospora beticola, Cladobotryum mycophilum, Cladosporium fulvum, Claviceps purpurea, Colletotrichum acutatum, Colletotrichum capsici, Colletotrichum coccodes, Colletotrichum destructivum, Colletotrichum gloeosporioides, Colletotrichum lindemuthianum, Colletotrichum orbiculare, Didymella pinodes, Erysiphe cichoracearum, Fusarium avenaceum, Fusarium culmorum, Fusarium graminearum, Fusarium oxysporum, Fusarium sambucinum, Fusarium solani, Fusarium udum, Fusarium verticillioides, Hemileia vastatrix, Hyaloperonospora parasitica, Magnaporthe oryzae, Melampsora lini, Microdochium majus, Monilinia fructicola, Monilinia laxa, Monilinia polystroma, Monilinia vaccinii-corymbosi, Mycosphaerella graminicola, Neofabraea vagabunda, Oculimacula acuformis, Oculimacula yallundae, Penicillium digitatum, Penicillium expansum, Penicillium italicum, Peronospora viciae, Phakopsora pachyrhizi, Phomopsis cucurbitae, Phomopsis obscurans, Phomopsis viticola, Phytophthora infestans, Phytophthora syringae, Pilidiella granati, Plasmopara halstedii, Plasmopara viticola, Pseudoperonospora cubensis, Puccinia graminis, Puccinia hordei, Puccinia melanocephala, Puccinia polysora, Puccinia recondita, Puccinia sorghi, Puccinia striiformis, Puccinia triticina, Pyrenochaeta lycopersici, Pyrenopeziza brassicae, Pyrenophora teres, Ramularia collo-cygni, Ramularia necator, Rhizoctonia solani, Sclerospora graminicola, Sclerotinia sclerotiorum, Septoria apiicola, Sphaerotheca fuligina, Stagonosporopsis cucurbitacearum, Stemphylium vesicarium, Taphrina deformans, Ustilago hordei, Ustilago maydis, Ustilago tritici, Venturia inaequalis, Verticillium albo-atrum and Verticillium dahlia.

27. The use or method of claim 23, wherein the bacterium is selected from the group consisting of: Acidovorax avenae, Acidovorax citrulli, Agrobacterium tumefaciens, Ca. Liberibacter africanus, Ca. Liberibacter americanus, Ca. Liberibacter asiaticus, Ca. Liberibacter solanacearum, Ca. Phytoplasma americanum, Ca. Phytoplasma mali, Ca. Phytoplasma phoenicium, Ca. Phytoplasma pruni, Ca. Phytoplasma pyri, Ca. Phytoplasma solani, Ca. Phytoplasma ulmi, Citrus huanglongbing, Clavibacter michiganensis, Coconut lethal yellowing phytoplasma, Curtobacterium flaccumfaciens, Dickeya dadantii, Dickeya dianthicola, Dickeya solani, Dickeya zeae, Erwinia amylovora, Erwinia carotovora, Erwinia chrysanthemi, Erwinia stewartii, Grapevine flavescence doree phytoplasma, Pantoea stewartii, Peach rosette phytoplasma, Peach yellows phytoplasma, Pectobacterium atrosepticum, Pectobacterium brasiliense, Pectobacterium carotovorum, Pectobacterium parmentieri, Pseudomonas avenae, Pseudomonas syringae, Ralstonia pseudosolanacearum, Ralstonia solanacearum, Ralstonia solanacearum, Ralstonia syzygii, Streptomyces scabiei, Xanthomonas albilineans, Xanthomonas arboricola, Xanthomonas axonopodis, Xanthomonas campestris, Xanthomonas citri, Xanthomonas cynarae, Xanthomonas euvesicatoria, Xanthomonas fragariae, Xanthomonas hortorum, Xanthomonas oryzae, Xanthomonas phaseoli, Xanthomonas translucens, Xanthomonas vesicatoria, Xylella fastidiosa and Xylophilus ampelinus.

28. The use or method of claim 24, wherein the nematode is selected from the group consisting of: Aphelenchoides besseyi, Anguina tritici, Belonolaimus longicaudatus, Ditylenchus angustus, Ditylenchus dipsaci, Ditylenchus africanus, Ditylenchus destructor, Globodera pallida, Globodera rostochiensis, Heterodera avenae, Heterodera cruciferae, Heterodera filipjevi, Heterodera glycines, Heterodera schachtii, Meloidogyne arenaria, Meloidogyne chitwoodi, Meloidogyne fallax, Meloidogyne graminicola, Meloidogyne hapla, Meloidogyne incognita, Meloidogyne javanica, Nacobbus aberrans, Nacobbus dorsalis, Nacobbus serendipiticus, Pratylenchus brachyurus, Pratylenchus coffeae, Pratylenchus neglectus, Pratylenchus penetrans, Pratylenchus thornei, Pratylenchus vulnus, Pratylenchus zeae, Radopholus similis, Rotylenchulus reniformis, Rotylenchulus parvus, Tylenchulus semipenetrans, Xiphinema americanum, Xiphinema diversicaudatum, Xiphinema index and Xiphinema vuittenezi.

29. The use or method of claim 25, wherein the insect is selected from the group consisting of: aphids (family: Aphididae), balsam woolly adelgid (family: Adelgidae), grape Phylloxera (family: Phylloxeridae), scale insects (family: Monophlebidae), soft scales (family: Coccidae), whiteflies (family Aleyrodidae), armyworms (family: Noctuidae), beetles (family: Chrysomelidae), sunflower headclipping weevil (family: Attelabidae), cabbage seedpod weevil, pea leaf weevil (family: Curculionidae), true bugs (family: Lygaeidae), black grass bugs (family: Miridae), caterpillars (family: Pyralidae), stalk borers (family: Crambidae), cabbage moth (family: Geometridae), corn earworm moth (family: Noctuidae), mites (family: Tetranychidae), thread-footed mites (family: Tarsonemidae), gall mites (family Eriophyidae)), Thrips (family: Thripidae), western flower Thrips (family: Aeolothripidae), banded flower Thrips (family: Phlaeothripidae), sawflies (family: Cephidae), flies (family Cecidomyiidae), and cherry fruit flies (family: Tephritidae).

30. The use or method of any one of claims 17 to 29, wherein said plant is an agricultural plant, vegetable or fruit, optionally wheat, barley, oat, rye, soybean, corn, potatoes, oilseed rape, canola, sunflower, cotton, sugar cane, sugar beet, rice, apple, walnut, pea, loquat, Narcissus, cucumber, apricot, plum, peach, beans, mushrooms, grapevine, Dianthus, Citrus fruit, spinach, lettuce, tomato, asparagus, cabbages, sorghum, pear, strawberry, sweet pepper, carrot, onion, celery, blackberry, linseed, or leek; a silvicultural plant; an ornamental plant; or a horticultural plant.

31. Method for the preparation of a chitosan-coated o/w (oil-in-water) emulsion, said chitosan-coated emulsion comprising an aqueous continuous phase and a non-aqueous dispersed phase,
wherein the dispersed phase is in the form of droplets dispersed in the continuous phase, said droplets being at least partially coated with at least one chitosan, the method comprising the steps of:
e) providing an aqueous phase comprising said at least one chitosan,
f) providing an organic phase comprising at least one water-miscible organic solvent, at least one emulsifier, at least one agricultural active and optionally at least one carrier (oil),
g) emulsifying the organic phase in the aqueous phase, and
h) optionally, reducing the volume of the emulsion obtained in step c) to about 25% to 80% of its original volume, optionally by means of evaporation.

32. The method of claim 31, wherein the chitosan is comprised in an amount of from 0.01 to 5% (w/v), preferably in an amount of 0.02 to 1% (w/v), more preferably in an amount of 0.05 to 0.5% (w/v) in the aqueous phase in step a).

33. The method of claim 31 or 32, wherein the aqueous phase in step a) comprises glycerol, optionally in an amount of from 10 to 50% (v/v).

34. The method of any one of claims 31 to 33, wherein the at least one emulsifier is comprised in an amount of from 0.05 to 2% (w/v), preferably in an amount of 0.1 to 1% (w/v), more preferably in an amount of 0.2 to 0.8% (w/v) in the organic phase in step b).

35. The method of any one of claims 31 to 34, wherein the at least one water-miscible organic solvent is selected from the group consisting of monohydric alcohols such as methanol, ethanol, propanol, isopropanol, n-butanol and t-butanol; dihydric alcohols such as glycols such as propylene glycol, ethylene glycol, tetraethylene glycol, triethylene glycol, trimethylene glycol; trihydric alcohols such as glycerin, butane-1,2,3-triol, pentane-1,3,5-triol, 2-amino-2-hydroxymethyl-propane-1,3-diol; and other alcohols and/or is present in an amount of from 99 to 30% (v/v), preferably in an amount of 96 to 50% (v/v), more preferably in an amount of 93 to 80% (v/v) in the organic phase of step b).

36. The method of any one of claims 31 to 35, wherein the at least one carrier (oil) is comprised in an amount of from 0.01 to 5% (v/v), preferably in an amount of 0.2 to 2% (v/v), more preferably in an amount of 0.5 to 1.5% (v/v) in the organic phase in step b).

37. The method of any one of claims 31 to 36, wherein, in step d), the volume of the emulsion is reduced to about 25% to 55% of its original volume and
(1) the chitosan is present in an amount of from 0.02 to 0.5% (w/v), preferably in an amount of 0.05 to 0.2% (w/v) in the aqueous phase in step a); and/or
(2) the emulsifier is present in an amount of from 0.05 to 2% (w/v), preferably in an amount of 0.2 to 0.8% (w/v) in the organic phase in step b).

38. The method of any one of claims 31 to 36, wherein, in step d), the volume of the emulsion is reduced to about 55% to 80% of its original volume and
(1) the chitosan is present in an amount of from 0.05 to 0.8% (w/v), preferably in an amount of 0.1 to 0.4% (w/v) in the aqueous phase in step a); and/or
(2) the emulsifier is present in an amount of from 2 to 10% (w/v), preferably in an amount of 4 to 8% (w/v) in the organic phase in step b).

39. The method according to claim 37 or 38, wherein the at least one agricultural active is present in an amount of from 0.5 to 50% (v/v) in the organic phase of step b), preferably 1 to 8% (v/v).

40. Chitosan-coated emulsion obtainable by a method according to any one of claims 31 to 39.

41. Plant treatment composition comprising a chitosan-coated emulsion obtainable by a method according to any one of claims 31 to 39.
